(19) United States
(12) Patent Application Publication
(10) Pub. No.: US 2025/0350425 A1
(43) Pub. Date: Nov. 13, 2025

(54) SOUNDING REFERENCE SIGNAL COMPRESSION TECHNIQUES FOR SOUNDING REFERENCE SIGNAL REPORTING

(71) Applicant: QUALCOMM Incorporated, San Diego, CA (US)

(72) Inventors: In-Soo KIM, San Diego, CA (US); Yu ZHANG, San Diego, CA (US); Jing SUN, San Diego, CA (US); Jing JIANG, San Diego, CA (US); Andrei Dragos RADULESCU, La Jolla, CA (US)

(21) Appl. No.: 18/658,371

(22) Filed: May 8, 2024

(51) Int. Cl. H04L 5/00; H04W 8/22; H04W 16/28

(52) U.S. Cl. CPC H04L 5/0051; H04W 8/22; H04W 16/28

(57) ABSTRACT

Methods, systems, and devices for wireless communications are described. The described techniques relate to improved methods, systems, devices, and apparatuses that support sounding reference signal (SRS) compression techniques for SRS reporting. For example, the described techniques may enable a radio unit (RU) to compress a received SRS signal to reduce a payload of an SRS report. For example, the RU may compress the received SRS signal from a frequency-antenna domain into a delay-beam domain. The RU may accordingly transmit the SRS report to a distributed unit (DU) with a relatively smaller payload than a non-compressed SRS report. The DU may recover the non-compressed received SRS signal from the compressed SRS signal and configure the RU with a precoder based on the received SRS signal. In some examples, the DU may configure the RU to perform SRS compression based on a capability of the RU to perform sparse SRS compression.

### FIELD OF TECHNOLOGY

The following relates to wireless communications, including sounding reference signal compression techniques for sounding reference signal reporting.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support sounding reference signal (SRS) compression techniques for SRS reporting. For example, the described techniques may enable a radio unit (RU) to compress a received SRS signal to reduce a payload of an SRS report. In such cases, the RU may compress the received SRS signal from a frequency-antenna domain into a delay-beam domain. The RU may accordingly transmit the SRS report to a distributed unit (DU) having a relatively smaller payload than a non-compressed SRS report. The DU may recover the non-compressed received SRS signal from the compressed SRS signal and configure the RU with a precoder based on the received SRS signal. In some examples, the DU may configure the RU to perform SRS compression based on a capability of the RU to perform sparse SRS compression.

A method for wireless communications by an RU is described. The method may include obtaining, from one or more user equipments (UEs), a set of multiple SRSs, generating a compressed SRS based on obtaining the set of multiple SRSs, the compressed SRS corresponding to a sparse representation that is indicative of one or more SRSs of the set of multiple SRSs, and outputting, to a DU, a SRS report indicating the compressed SRS.

An RU for wireless communications is described. The RU may include one or more memories storing processor executable code, and one or more processors coupled with the one or more memories. The one or more processors may individually or collectively be operable to execute the code to cause the RU to obtain, from one or more UEs, a set of multiple SRSs, generate a compressed SRS based on obtaining the set of multiple SRSs, the compressed SRS corresponding to a sparse representation that is indicative of one or more SRSs of the set of multiple SRSs, and output, to a DU, a SRS report indicating the compressed SRS.

Another RU for wireless communications is described. The RU may include means for obtaining, from one or more UEs, a set of multiple SRSs, means for generating a compressed SRS based on obtaining the set of multiple SRSs, the compressed SRS corresponding to a sparse representation that is indicative of one or more SRSs of the set of multiple SRSs, and means for outputting, to a DU, a SRS report indicating the compressed SRS.

A non-transitory computer-readable medium storing code for wireless communications is described. The code may include instructions executable by one or more processors to obtain, from one or more UEs, a set of multiple SRSs, generate a compressed SRS based on obtaining the set of multiple SRSs, the compressed SRS corresponding to a sparse representation that is indicative of one or more SRSs of the set of multiple SRSs, and output, to a DU, a SRS report indicating the compressed SRS.

In some examples of the method, RUs, and non-transitory computer-readable medium described herein, generating the compressed SRS may include operations, features, means, or instructions for applying a resource element (RE) demapping to the one or more SRSs of the set of multiple SRSs to obtain one or more groups of SRS resources and generating a projection of the one or more SRSs for each group of the one or more groups, where generating the projection includes projecting each of the one or more SRSs from a frequency-antenna domain representation onto a delay-beam domain representation.

Some examples of the method, RUs, and non-transitory computer-readable medium described herein may further include operations, features, means, or instructions for outputting a capability message indicating one or more signal processing capabilities of the RU, where the one or more signal processing capabilities include a capability of the RU to perform a demapping procedure, a descrambling procedure, and an inverse fast Fourier transform (iFFT) procedure on the one or more sounding references signals, where generating the compressed SRS may be based on the one or more signal processing capabilities.

Some examples of the method, RUs, and non-transitory computer-readable medium described herein may further include operations, features, means, or instructions for obtaining a control message configuring the RU to generate the compressed SRS, where generating the compressed SRS may be based on the control message.

Some examples of the method, RUs, and non-transitory computer-readable medium described herein may further include operations, features, means, or instructions for generating the compressed SRS may be based on the one or more signal processing capabilities of the RU.

In some examples of the method, RUs, and non-transitory computer-readable medium described herein, the control message indicates that the RU use a sparse SRS compression mode for outputting the SRS report and the sparse SRS compression mode may be associated with an iFFT size for projecting the one or more SRSs from a frequency-antenna domain representation onto a delay-beam domain representation, a threshold associated with one or more near-zero elements of the delay-beam domain representation, or both.

Some examples of the method, RUs, and non-transitory computer-readable medium described herein may further include operations, features, means, or instructions for obtaining a control message indicating a SRS resource configuration, where obtaining the set of multiple SRSs may be based on the SRS resource configuration.

In some examples of the method, RUs, and non-transitory computer-readable medium described herein, the SRS resource configuration includes an indication of a SRS resource identifier (ID), a time domain resource position, a frequency domain resource position, a resource type, a base sequence, or any combination thereof.

Some examples of the method, RUs, and non-transitory computer-readable medium described herein may further include operations, features, means, or instructions for identifying one or more SRS resource that may be activated or deactivated based on the SRS resource ID, where the SRS resource ID indicates whether the SRS resource configuration may be associated with an aperiodic trigger or a semi-persistent trigger.

Some examples of the method, RUs, and non-transitory computer-readable medium described herein may further include operations, features, means, or instructions for outputting, via the SRS report, an indication of one or more nonzero elements associated with the compressed SRS and an indication of a respective delay-beam index associated with each of the one or more nonzero elements.

A method for wireless communications by a DU is described. The method may include obtaining, from an RU, an SRS report indicating a compressed SRS, the compressed SRS corresponding to a sparse representation that is indicative of one or more SRSs and recovering the one or more SRSs based on obtaining the compressed SRS.

A DU for wireless communications is described. The DU may include one or more memories storing processor executable code, and one or more processors coupled with the one or more memories. The one or more processors may individually or collectively be operable to execute the code to cause the DU to obtain, from an RU, an SRS report indicating a compressed SRS, the compressed SRS corresponding to a sparse representation that is indicative of one or more SRSs and recover the one or more SRSs based on obtaining the compressed SRS.

Another DU for wireless communications is described. The DU may include means for obtaining, from an RU, an SRS report indicating a compressed SRS, the compressed SRS corresponding to a sparse representation that is indicative of one or more SRSs and means for recovering the one or more SRSs based on obtaining the compressed SRS.

A non-transitory computer-readable medium storing code for wireless communications is described. The code may include instructions executable by one or more processors to obtain, from an RU, an SRS report indicating a compressed SRS, the compressed SRS corresponding to a sparse representation that is indicative of one or more SRSs and recover the one or more SRSs based on obtaining the compressed SRS.

In some examples of the method, DUs, and non-transitory computer-readable medium described herein, recovering the received SRS may include operations, features, means, or instructions for generating a projection of the compressed SRS, where generating the projection includes projecting the compressed SRS from a delay-beam domain representation onto a frequency-antenna domain representation.

Some examples of the method, DUs, and non-transitory computer-readable medium described herein may further include operations, features, means, or instructions for obtaining a capability message indicating one or more signal processing capabilities of the RU, where the one or more signal processing capabilities include a capability of the RU to perform a demapping procedure, a descrambling procedure, and an iFFT procedure on the one or more sounding references signals, where obtaining the SRS report indicating the compressed SRS may be based on the one or more signal processing capabilities.

Some examples of the method, DUs, and non-transitory computer-readable medium described herein may further include operations, features, means, or instructions for outputting a control message configuring the RU to generate the compressed SRS, where obtaining the SRS report indicating the compressed SRS may be based on the control message.

In some examples of the method, DUs, and non-transitory computer-readable medium described herein, the compressed SRS may be based on the one or more signal processing capabilities.

In some examples of the method, DUs, and non-transitory computer-readable medium described herein, the control message indicates that the RU use a sparse SRS compression mode for outputting the SRS report and the sparse SRS compression mode may be associated with an iFFT size for projecting the one or more SRSs from a frequency-antenna domain representation onto a delay-beam domain representation, a threshold associated with one or more near-zero elements of the delay-beam domain representation, or both.

Some examples of the method, DUs, and non-transitory computer-readable medium described herein may further include operations, features, means, or instructions for outputting a control message indicating a SRS resource configuration, where obtaining the SRS report indicating the compressed SRS may be based on the control message.

In some examples of the method, DUs, and non-transitory computer-readable medium described herein, the SRS resource configuration includes an indication of a SRS resource ID, a time domain resource position, a frequency domain resource position, a resource type, a base sequence, or any combination thereof.

In some examples of the method, DUs, and non-transitory computer-readable medium described herein, one or more SRS resource that may be activated or deactivated may be indicated by the SRS resource ID and the SRS resource ID indicates whether the SRS resource configuration may be associated with an aperiodic trigger or a semi-persistent trigger.

Some examples of the method, DUs, and non-transitory computer-readable medium described herein may further include operations, features, means, or instructions for obtaining, via the SRS report, an indication of one or more nonzero elements associated with the compressed SRS and an indication of a respective delay-beam index associated with each of the one or more nonzero elements.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 shows an example of a wireless communications system that supports sounding reference signal (SRS) compression techniques for SRS reporting in accordance with one or more aspects of the present disclosure.

FIG. 2 shows an example of a network architecture that supports SRS compression techniques for SRS reporting in accordance with one or more aspects of the present disclosure.

FIG. 3 shows an example of a wireless communications system that supports SRS compression techniques for SRS reporting in accordance with one or more aspects of the present disclosure.

FIG. 4 shows an example of a process flow that supports SRS compression techniques for SRS reporting in accordance with one or more aspects of the present disclosure.

FIGS. 5 and 6 show block diagrams of devices that support SRS compression techniques for SRS reporting in accordance with one or more aspects of the present disclosure.

FIG. 7 shows a block diagram of a communications manager that supports SRS compression techniques for SRS reporting in accordance with one or more aspects of the present disclosure.

FIG. 8 shows a diagram of a system including a device that supports SRS compression techniques for SRS reporting in accordance with one or more aspects of the present disclosure.

FIGS. 9 through 14 show flowcharts illustrating methods that support SRS compression techniques for SRS reporting in accordance with one or more aspects of the present disclosure.

### DETAILED DESCRIPTION

In some wireless communications systems, a radio unit (RU) may communicate with one or more UEs. The one or more UEs may transmit sounding reference signals (SRSs) to the RU. The RU may transmit an indication of the received SRS signals (e.g., an SRS report) to a distributed unit (DU), which may perform channel estimation to calculate a precoder based on the SRSs. The DU may configure the RU with the precoder, which the RU may apply to a set of downlink data for the one or more UEs. In some examples, a payload of the SRS report may be proportional to a quantity of antennas of the RU (e.g., a quantity of antennas used to receive the SRSs) and a sounding bandwidth (e.g., a bandwidth over which the RU received the SRSs). Accordingly, for a system with a relatively larger sounding bandwidth and quantity of antennas than some other systems, the SRS report may be associated with a large traffic burst on a channel (e.g., a fronthaul channel) between the RU and the DU, which may increase latency and be associated with inefficiencies in the system.

The techniques described herein may enable the RU to compress the received SRS(s) to reduce a payload of the SRS report. For example, the RU may compress the received SRS from a frequency-antenna domain into a delay-beam domain. The RU may accordingly transmit the SRS report to the DU with a relatively smaller payload than a non-compressed SRS report. The DU may recover the non-compressed received SRS from the compressed SRS and configure the RU with a precoder based on the received SRS. In some examples, the DU may configure the RU to perform SRS compression based on a capability of the RU to perform sparse SRS compression. By transmitting a compressed the SRS report, the RU may transmit an SRS report having a relatively smaller payload than an uncompressed SRS report, which may prevent relatively large traffic bursts related to SRS reporting and may therefore decrease latency in the system.

Aspects of the disclosure are initially described in the context of wireless communications systems. Aspects of the disclosure are further illustrated by and described with reference to process flows, apparatus diagrams, system diagrams, and flowcharts that relate to SRS compression techniques for SRS reporting.

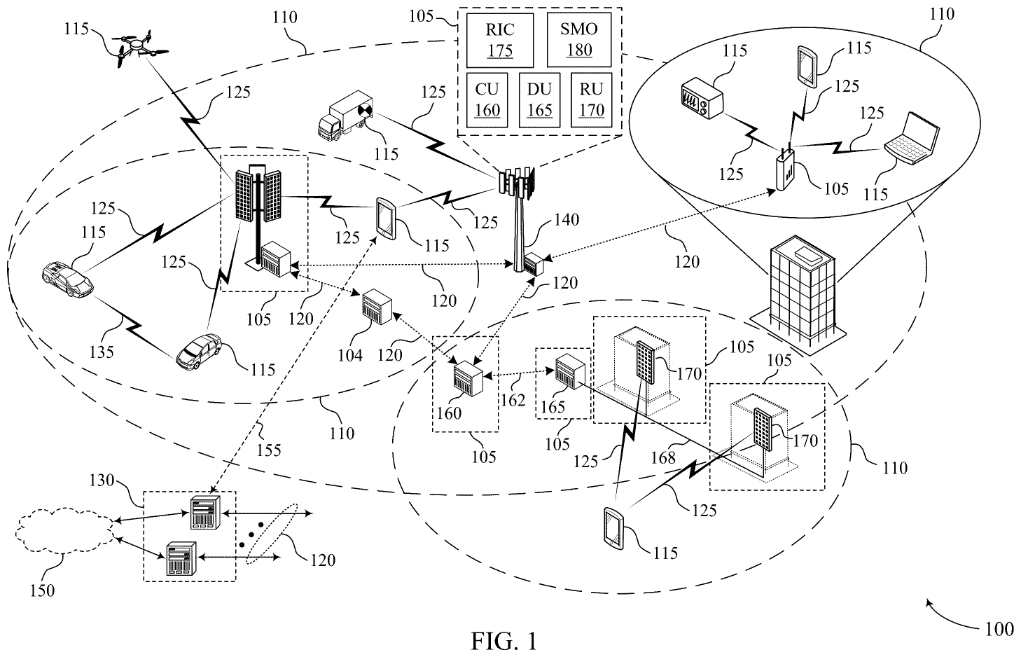

FIG. 1 shows an example of a wireless communications system 100 that supports SRS compression techniques for SRS reporting in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a DU, such as a DU 165, an RU, such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, an RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

An SRS may be transmitted by a UE 115 using a predetermined sequence (e.g., a Zadoff-Chu (ZC) sequence) so that a network entity 105 may estimate the uplink channel quality. An SRS transmission may not be associated with transmission of data on another channel, and may be transmitted periodically on a relatively wide bandwidth (e.g., a bandwidth including more subcarriers than are allocated for uplink data transmission). In some examples, an SRS may be scheduled on multiple antenna ports and still considered to be a single SRS transmission. An SRS transmission may be categorized as periodic SRS (periodically transmitted at equally spaced intervals) or as an aperiodic SRS. In either case, the network entity 105 may control the timing of SRS transmissions by notifying the UE 115 of which TTIs (e.g., subframes) may support the transmission of the SRS. Additionally, a sounding period (e.g., 2 to 230 subframes) and an offset within the sounding period may be configured for the UE 115. As a result, the UE 115 may transmit the SRS when a subframe that supports SRS transmissions coincides with the configured sounding period. In some cases, the SRS may be transmitted during a temporally last OFDM symbol of the subframe or, in some cases, may be sent during an uplink portion of a special subframe. Data gathered by a network entity 105 from an SRS may be used to inform the scheduling of uplink transmissions by the UE 115, such as frequency-dependent transmissions. In some cases, a network entity 105 may use an SRS to check timing alignment status and send time alignment commands to the UE 115.

According to some SRS compression techniques described herein, an RU 170 may compress one or more SRSs received from one or more UEs 115 to reduce a payload of an SRS report. For example, the RU 170 may compress the received SRSs from a frequency-antenna domain into a delay-beam domain. The RU 170 may accordingly transmit the SRS report to a DU 165 with a relatively smaller payload than a non-compressed SRS report. The DU 165 may recover the non-compressed received SRS from the compressed SRS information and configure the RU 170 with a precoder based on the received SRS(s). In some examples, the DU 165 may configure the RU 170 to perform SRS compression based on a capability of the RU 170 to perform sparse SRS compression.

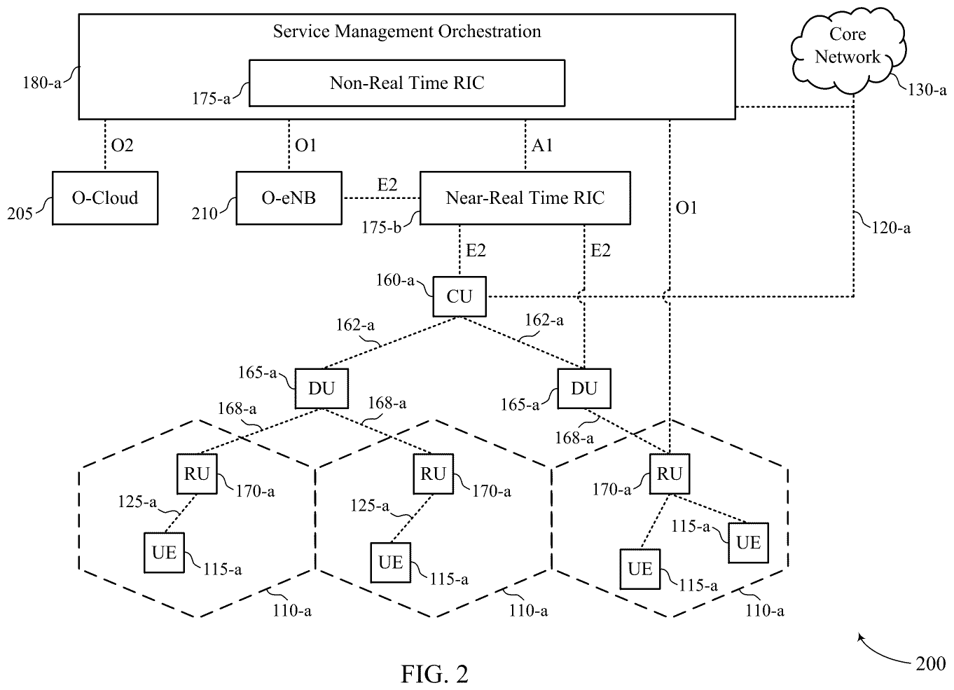

FIG. 2 shows an example of a network architecture 200 (e.g., a disaggregated base station architecture, a disaggregated RAN architecture) that supports SRS compression techniques for SRS reporting in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via 01) or via generation of RAN management policies (e.g., A1 policies).

The network architecture 200 may support techniques for reducing the payload of one or more SRS reports via the compression of SRS information sent between an RU 170-a and a DU 165-a. For example, in accordance with some SRS compression techniques described herein, an RU 170-a may compress one or more received SRSs to reduce a payload of an SRS report. For example, the RU 170-a may compress the received SRS from a frequency-antenna domain into a delay-beam domain. The RU 170-a may accordingly send the SRS report (e.g., a compressed SRS report) to a DU 165-a with a relatively smaller payload than a non-compressed SRS report. The DU 165-a may recover the non-compressed received SRS(s) from the compressed SRS information and configure the RU 170-a with a precoder based on the received SRS(s). In some examples, the DU 165-a may configure the RU 170-a to perform SRS compression, which may be based on a capability of the RU 170-a to perform sparse SRS compression.

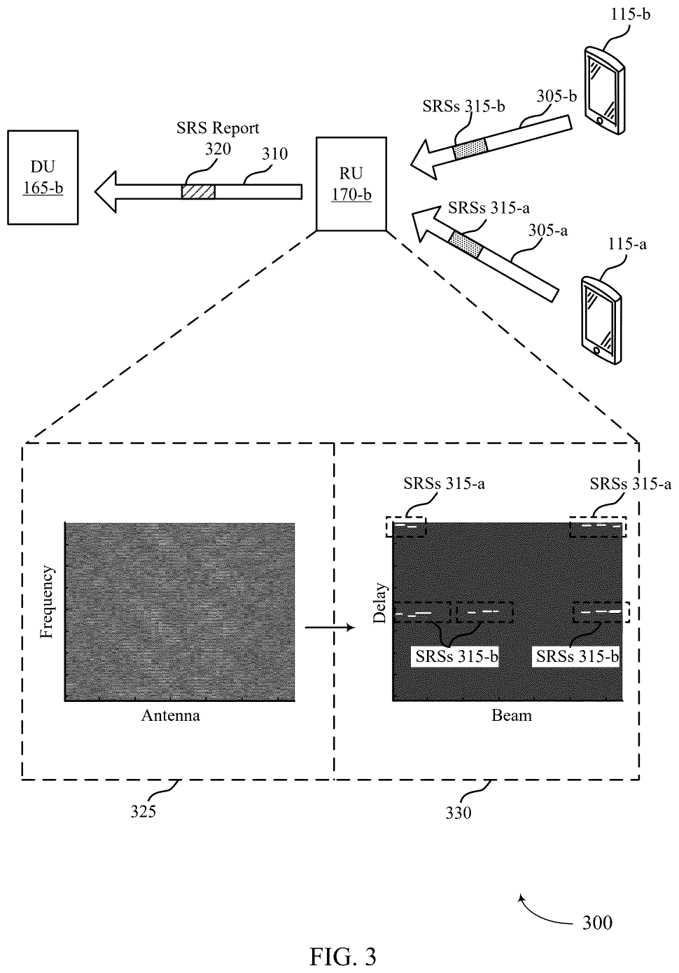

FIG. 3 shows an example of a wireless communications system 300 that supports SRS compression techniques for SRS reporting in accordance with one or more aspects of the present disclosure. The wireless communications system 300 may implement or may be implemented by aspects of the wireless communications system 100 or the network architecture 200. For example, the wireless communications system 300 may include one or more UEs 115 (e.g., a UE 115-a and a UE 115-b), a DU 165 (e.g., DU 165-b), and an RU 170 (e.g., an RU 170-b), which may be examples of the corresponding devices as described with reference to FIG. 1 and FIG. 2.

In some examples of the wireless communications system 300, one or more devices (e.g., a DU 165-b, an RU 170-b, a UE 115-a, a UE 115-b) may communicate using frequency bands that are in an upper middle band, such as frequency range 3 (FR3), and a millimeter wave (mmWave) band, such as frequency range 2 (FR2) (e.g., 13 to 28 gigahertz (GHz), as compared to a sub-6 GHz low and middle frequency band). Such upper-mid and mmWave frequency bands may experience relatively higher pathloss and therefore relatively reduced coverage as compared to lower frequency bands (e.g., frequency range 1 (FR1)).

Accordingly, one or more network entities (e.g., the DU 165-b, the RU 170-b) operating in FR2 or FR3 may use a relatively larger quantity of antenna elements as compared to network entities operating in FR1. For example, a low- or mid-band network entity (e.g., operating in frequency ranges below 6 GHZ) may include 2, 4, 8, 16, 32, or 64 transceiver units (TxRUs), while an upper mid-band (e.g., FR3) network entity may include 128 or 256 TxRUs (e.g., with up to four thousand antenna elements for giga MIMO communications). However, for such relatively larger antenna array configurations to enable relatively increased coverage (e.g., as compared to relatively smaller antenna array configurations), the network entities (e.g., the DU 165-b, the RU 170-b) may use relatively more accurate precoding to form communication beams. Accordingly, the network entities may use relatively more accurate channel estimation for precoding.

As described with reference to FIG. 2, for O-RAN architectures, one or more functionalities may be split between multiple nodes (e.g., the DU 165-b, the RU 170-b) to accommodate more flexibility in RAN design, which may increase interoperability between one or more vendors. In one example, a 7.2× split architecture may include three units (e.g., a CU, the DU 165-b, and the RU 170-b). In such architectures, the CU may host a PDCP layer, an RRC layer, and an SDAP layer. The DU 165-b may host an RLC layer, a MAC layer, and high-PHY layers. The RU 170-c may host low-PHY layers and may perform RF processing.

The DU 165-b and the RU 170-c may exchange data between the high-PHY layer and the low-PHY layer through a fronthaul link 310 that connects the DU 165-b and the RU 170-c. For example, to perform channel estimation, the RU 170-b may receive one or more SRSs 315 from one or more UEs 115 (e.g., the UE 115-a, the UE 115-b). The RU 170-b may output an indication of a received SRS signal to the DU 165-b in an SRS report 320 via the fronthaul link 310 (e.g., in the uplink). The DU 165-b may accordingly perform channel estimation of one or more channels 305 (e.g., a channel 305-a, a channel 305-b) between the RU 170-b and the one or more UEs 115 based on the received SRS signal.

The SRSs 315 may be transmitted using an SRS transmission base sequence generated based on an extended ZC sequence. Each base sequence (e.g., each sequence associated with a different cyclic shift (CS)) may be orthogonal. That is, a set of CSs may yield a set of orthogonal SRS transmission sequences. The SRSs 315 may be transmitted by the UEs 115 and received by the RU 170-b over an SRS bandwidth with various time, frequency, and CS configurations (e.g., to enable multiplexing multiple antenna ports and UEs 115 in time, frequency, and CS domains). The network may schedule SRS resources to have different slot offsets for different UEs (e.g., by configuring a parameter slotOffset) for TDM, different comb offsets for different UEs (e.g., by configuring a parameter combOffset) for FDM, and/or different CRs for different UEs (e.g., by configuring a parameter cyclicShift) for code division multiplexing (CDM).

For example, for TDM, the UE 115-a may transmit SRSs 315-a via first time resources and the UE 115-b may transmit SRSs 315-b via second time resources that may not overlap with the first time resources (e.g., with different slot offsets). For FDM, the UE 115-a may transmit the SRSs 315-a via first frequency resources and the UE 115-b may transmit the SRSs 315-b via second frequency resources that may not overlap with the first frequency resources (e.g., with different comb offsets). For CDM, the UE 115-a may transmit the SRSs 315-a with a first cyclic shift and the UE 115-b may transmit the SRSs 315-b with a second cyclic shift different from the first cyclic shift. As an illustrative example, the UEs 115 may identify 16 SRS resources by using two different comb offsets and 8 different CSs (e.g., FDM and CDM). Similarly, the UEs 115 may identify 16 SRS resources by using two different slot offsets and 8 different CSs (e.g., TDM and CDM). The SRSs 315 may be periodic (e.g., with RRC configured resources), aperiodic (e.g., with downlink control information (DCI) configured or triggered resources), or semi-persistent (e.g., with medium access control-control information (MAC-CE) configured or triggered resources).

After performing the channel estimation, the DU 165-b may output an indication of one or more precoders for the RU 170-b to use for communications with the one or more UEs 115 (e.g., and a downlink payload, such as a physical downlink shared channel (PDSCH) data for the RU 170-b to transmit to the one or more UEs 115) to the RU 170-b via the fronthaul link 310 (e.g., in the downlink). The RU 170-b may apply the indicated precoding to the PUSCH data and transmit the PUSCH data to the UEs 115.

A payload associated with the RU 170-b indicating the received one or more SRSs to the DU 165-b may be proportional to an SRS bandwidth (e.g., a bandwidth over which the SRSs 315 are transmitted) and a quantity of TxRUs of the RU 170-b. For example, the payload may be a quantity of SRS tones multiplied by the quantity of TxRUs and a quantity of bits per in-phase and quadrature (I/Q) sample. Thus, as a system scales up (e.g., to serve relatively more UEs 115 and to include relatively more antenna elements), the indication of the received SRS information may have a relatively larger payload, which may result in a traffic burst on the fronthaul link 310.

As an illustrative example, an FR3 giga MIMO system may have a 100 megahertz (MHz) bandwidth (e.g., with 272 resource blocks (RBs), 3264 system tones, and 1632 SRS tones), a subcarrier spacing (SCS) of 30 kilohertz (kHz), and 256 TxRUs (e.g., at the RU 170). A PDSCH to be transmitted by the RU 170 may be transmitted via a 4 RB bundle using a modulation and coding scheme (MCS) of 20 (e.g., 265 quadrature amplitude modulation (QAM)) and via four subchannels (e.g., rank 4). The SRSs 315 may be transmitted as comb-2 (e.g., with two comb offsets) and CS 8 (e.g., with 8 different CSs) with 16 bits per I/Q sample (e.g., using a block floating point (BPF) compression method).

In such an example, at each SRS symbol, a payload for the RU 170-b to indicate the received SRS information (e.g., the quantity of SRS tones (1632) multiplied by the quantity of TxRUs or antennas at the RU 170-b (256) and the bits per I/Q sample (16)) may be 6.68 megabits (Mbits). Conversely, a payload for PDSCH data applied at each PDSCH symbol may be the quantity of system tones multiplied by the quantity of layers and the modulation order (e.g., 3264*4*8 or 0.1 Mbits) A payload for precoders applied at each PDSCH symbol may be the quantity of physical resource groups (PRGs) multiplied by the quantity of layers, the quantity of TxRUs of the RU 170-b, and the bits per I/Q sample (e.g., 68*256*4*16 or 1.11 Mbits). That is, the total payload for the DU 165-b to indicate the PDSCH data and precoders to the RU 170-b applied at each PDSCH symbol may be 1.21 Mbits. Accordingly, the payload for the indication of the received SRS information may, for example, be about 5.52 times larger than the PDSCH data and precoder payload. The received SRS indication may therefore become similar to a main traffic burst, which may impose delays or other inefficiencies on the fronthaul link 310.

Accordingly, techniques described herein may enable the RU 170-b to generate an indicate a sparse representation (e.g., a delay-beam domain representation 330) of the one or more SRSs received by the RU 170-b (which may be referred to as SRS information, an SRS signal, or some similar terminology). That is, the RU 170-b may use a frequency-antenna domain representation 325 of the received SRS(s) to generate the delay-beam domain representation 330 using a relatively small quantity of propagation paths constituting the channel 305-a and the channel 305-b in FR2 and FR3 (e.g., as compared to channels 305 with relatively lower pathloss).

For example, the RU 170-b may measure a frequency-domain channel H_{f}∈ [symbol] ^{K×M} (e.g., with K system tones) between the RU 170-b (e.g., an RU 170 with M antennas) and a single-antenna UE 115-a. In such examples, rows of H_{f} may correspond to system tones and columns of H_{f} may correspond to antennas of the RU 170-b. If the channel 305-a has a relatively small quantity of propagation paths, projecting the frequency domain channel H_{f} into a delay-beam domain representation of the channel may result in a relatively more sparse channel representation than the frequency-antenna domain representation of the channel. As described herein, a sparse representation may be a representation with relatively fewer non-zero elements (e.g., delay-beam indices with a measured power that is above a threshold) than non-zero elements of a dense representation (e.g., frequency-antenna indices with a measured power that is above the threshold). The delay-beam representation (e.g., delay-beam domain representation) of the channel may be defined according to Equation 1.

$${H}_{d} = {IDFT}_{K} * {H}_{f} * {IDFT}_{M}^{H} \qquad ( 1 )$$

As described with respect to Equation 1, H_{f} may be the frequency-antenna domain representation 325 of the channel and IDFTₙ (e.g., an inverse discrete Fourier transform (iDFT) may be defined as IDFTₙ∈ [symbol] ^{n×n}, where [symbol] ^{n×n} is an n-point iFFT matrix.

In some examples, two UEs 115 (e.g., the UE 115-a and the UE 115-b) may transmit SRSs 315 (e.g., SRSs 315-a and SRSs 315-b) over frequency resources spanning 1 SRS symbol and N SRS tones (e.g., CDM′ed SRSs 315 with different CSs) to the M-antenna RU 170-b. In such examples, a frequency-antenna domain representation 325 of the received SRS signal (e.g., received by the RU 170-b) may be represented by Y_{f}∈ [symbol] ^{N×M}, where rows of Y_{f} may correspond to the SRS tones and columns of Y_{f} may correspond to the antennas of the RU 170-b.

As described herein with reference to a frequency-domain representation of a channel, the RU 170-b may generate a delay-beam domain representation 330 of the received SRS signal using the frequency-antenna domain representation 325. For example, the RU 170-b may descramble the received SRS signal with the SRS transmission sequence. The RU 170-b may apply resource element (RE) demapping to the received SRS signal and group one or more SRS resources with a same time and frequency. For example, in a case in which 16 SRS resources are FDM′ed and CDM′ed over a combination of 2 comb offsets and 8 CSs, the RU 170-b may apply RE demapping to the received SRS signal such that the SRS resources may be demultiplexed into groups (e.g., two groups based on time and frequency resources, such as a first group with a first comb offset and 8 CSs and a second group with a second comb offset and 8 CSs).

For each group of SRS resources (e.g., with same time or frequency resources but different CSs), the RU 170-b may project the received SRS signal into the delay-beam domain (e.g., after descrambling with a base sequence r∈ [symbol] ^{N} that generates the SRS transmission sequences). That is, the RU 170-b may “sparsify” the received SRS signal by projecting the received SRS signal onto the delay-beam domain, which may generate the sparse representation of the received SRS signal (e.g., with a quantity of non-zero elements that is smaller than a quantity of non-zero elements of the dense frequency-antenna domain representation 325). The delay-beam domain representation 330 of the received SRS signal may be defined according to Equation 2.

$${Y}_{d} = {IDFT}_{K} * ( [ r … r ] {Y}_{f} ) * {IDFT}_{M}^{H} \qquad ( 2 )$$

As described with reference to Equation 2, r∈ [symbol] ^{N} may be a base sequence that the UE 115-a and the UE 115-b may use to generate the SRSs 315-a and the SRSs 315-b (e.g., with different CSs). The RU 170-b may determine one or more non-zero elements of the delay-beam domain representation 330 of the received SRS signal by determining one or more delay-beam indexes with received powers that are above a threshold. For example, the RU 170-b may identify one or more near-zero elements (e.g., elements of the delay-beam domain representation 330 with a power below the threshold) and may zero the near-zero elements. As illustrated with reference to FIG. 3, a first group of non-zero elements of the delay-beam domain representation 330 may represent H_{d} of the UE 115-a (e.g., measured via the SRSs 315-a) and a second group of non-zero elements of the delay-beam domain representation 330 may represent H_{d} of the UE 115-b (e.g., measured via the SRSs 315-b). The delay-beam domain representation 330 may have relatively fewer non-zero elements than the frequency-antenna domain representation 325.

The RU 170-b may transmit (e.g., forward) the SRS report 320 to the DU 165-b (e.g., via the fronthaul link 310) indicating the one or more non-zero elements of the delay-beam domain representation 330 (e.g., the delay-beam domain indexes of the non-zero elements and the received power of the non-zero elements), which may have a relatively smaller payload than an SRS report 320 indicating the frequency-antenna domain representation 325.

The DU 165-b may recover the original received SRSs (e.g., the frequency-antenna domain representation 325) from the delay-beam domain representation 330 by performing an inverse operation from Equation 2. For example, the recovered SRS information may be defined relative to the delay-beam domain representation of the SRSs according to Equation 3.

$${Y}_{f} = [ r … r ] ⊙ {DFT}_{N} * {Y}_{d} * {DFT}_{M}^{H} \qquad ( 3 )$$

As described herein, ⊙ and ∅ may denote element-wise multiplication and element-wise division, respectively. As described with respect to Equation 3, DFT n (e.g., a discrete Fourier transform (DFT) may be defined as DFTₙ∈ [symbol] ^{n×n}, where [symbol] ^{n×n} is an n-point FFT matrix. M may refer to an iFFT size associated with the frequency-antenna domain and N may refer to an iFFT size associated with the delay-beam domain.

In some examples, the RU 170-b may use a mode (e.g., a sparse SRS compression-decompression mode) for conveying the one or more received SRSs from the Ru 170-b to the DU 165-b efficiently (e.g., with a relatively smaller received SRS signal payload than the frequency-antenna domain representation 325). To support the sparse SRS compression-decompression mode, the RU 170-b may have signal processing capabilities to apply RE demapping, descrambling with the SRS transmission sequence, and performing iFFT to the received SRS signal. That is, the RU 170-b may be capable of beyond-low-PHY layer signal processing capabilities.

In some examples, the RU 170-b may share information with the DU 165-b for configuring the sparse SRS compression-decompression mode at the RU 170-b. In DU-RU split architecture, M-plane signaling may be signaling mechanisms responsible for non-real-time management between the DU 165-b and the RU 170-b (e.g., signaling between the DU 165-b and the RU 170-b during an initialization phase). C-plane signaling may be signaling mechanisms responsible for real-time control between the DU 165-b and the RU 170-b. U-plane signaling may be signaling mechanisms responsible for carrying a payload between the RU 170-b and the DU 165-b (e.g., the SRS report 320). Accordingly, the RU 170-b may inform the DU 165-b via M-plane signaling of the beyond-low-PHY layer signal processing capabilities of the RU 170-b (e.g., whether the RU 170-b is capable or not capable of performing Re demapping, descrambling, and iFFT).

The DU 165-b may transmit M-plane signaling to the RU 170-b configuring the RU 170-b to (e.g., in response to the signal processing capability of the RU 170-b). For example, the DU 165-b may determine, based on the signal processing capability of the RU 170-b, whether the RU 170-b supports the sparse SRS compression-decompression mode. If RE demapping, descrambling, and iFFT are supported at the RU 170-b, the DU 165-b may transmit M-plane signaling (e.g., via the fronthaul link 310) to the RU 170-b configuring the RU 170-b with the sparse SRS compression-decompression mode. If RE demapping, descrambling, and iFFT are not supported at the RU 170-b, the DU 165-b may transmit M-plane signaling (e.g., via the fronthaul link 310) to the RU 170-b configuring the RU 170-b to perform non-compressed SRS reporting (e.g., a fallback mode including reporting a raw received SRS signal rather than a compressed or sparse SRS signal). In some examples, the DU 165-b may update a configuration of the RU 170-b (e.g., to change between the sparse SRS compression-decompression mode and the fallback mode).

The DU 165-b may, additionally, or alternatively, transmit one or more parameters or instructions for the sparse SRS compression-decompression mode to the RU 170-b via M-plane signaling. The parameters or instructions may include an iFFT size M for projecting the received SRS signal from the frequency-antenna domain representation 325 into the delay-beam domain representation 330 and the threshold (e.g., a threshold power) for determining the near-zero elements of the delay-beam domain representation 330 of the received SRS signal (e.g., the elements that are not indicated to the DU 165-b via the SRS report 320).

In some examples, an SRS resource configuration (e.g., a configuration defining one or more resources via which the UEs 115 may transmit SRSs 315) may be updated (e.g., by a CU or the DU 165-b via M-plane signaling). Accordingly, the DU 165-b may inform the RU 170-b of the SRS resources (e.g., via M-plane or C-plane signaling). For example, the DU 165-b may transmit control signaling (e.g., RRC configuration) indicating SRS resources that are activated or deactivated, or aperiodic SRS triggering resources (e.g., time and frequency resources). The RU 170-b may group the SRS resources based on the resource configuration.

Upon RRC reconfiguration of SRS resources (e.g., an RRC message from a CU to the UEs 115 configuring SRS resources), the DU 165-b may indicate, to the RU 170-b, an SRS resource identifier (ID), a time domain position (e.g., parameters such as nrofSymbols, startPosition), a frequency domain position (e.g., parameters such as transmissionComb, combOffset, freqDomainPosition, freqDomainShift, freqHopping), a resource type (e.g., aperiodic resources that are triggered by DCI to the UEs 115, semi-persistent resources that are triggered by MAC-CE to the UEs 115, or periodic resources that are not triggered after configuring via RRC), a base sequence, and so on via M-plane signaling. Upon SRS triggering (e.g., if the DU 165-b transmits a DCI or MAC-CE message to the UEs 115 triggering aperiodic or semi-persistent SRSs), the DU 165-b may indicate SRS resource IDs to the RU 170-b via C-plane signaling indicating which SRS resources were activated or deactivated (e.g., via DCI or MAC-CE).

The RU 170-b may indicate the delay-beam domain representation 330 via U-plane signaling using a sparse SRS indication format. For example, rather than conveying a ray received SRS signal from the RU 170-b to the DU 165-b (e.g., which may result in a traffic burst with a payload of the quantity of SRS tones multiplied by the quantity of TxRUs and the quantity of bits per I/Q sample), the RU 170-b may convey the delay-beam domain representation 330 of the received SRS signal by conveying the non-zero elements and the delay-beam indices associated with the non-zero elements (e.g., a+bj on an (m, n)-th element of the delay-beam domain representation 330).

The payload of the SRS report 320 may be S{B+log₂(#SRS tones)(#TxRUs)} bits, where S represents the quantity of non-zero elements, which may be less than the quantity of SRS tones multiplied by the quantity of TxRUs, and B may be the quantity of bits per I/Q sample. As an illustrative example, in a case where SRSs are transmitted from 8 single-antenna UEs 115 and received by a 128 TxRU-RU 170-b (e.g., an RU 170 associated with/having 128 TxRUs) over 272 RBs via a 4 comb and 8 CS SRS resource configuration (e.g., with 816 SRS tones and one CS per UE 115), for 16 bit compression for each I/Q sample, the payload of a raw SRS signal may be 1.67 Mbits (e.g., a dense 816 by 128 matrix). Conversely, the received SRS signal may be 12078 non-zero elements, and the payload of the delay-beam domain representation 330 may therefore be 0.395 Mbits (e.g., a sparse 816 by 129 matrix).

In some examples, a mean square error (MSE) associated with channel estimation due to SRS compression may be based on the threshold for zeroing out the near-zero elements of the delay-beam domain representation 330 of the received SRS signal. For example, a throughput degradation associated with SRS-based PDSCH throughput and an error degradation associated with channel estimation may depend on a quantity of non-zero elements reported by the RU 170-b. In some examples, the PDSCH throughput degradation may be below a threshold (e.g., negligible) if the size of the payload of the SRS report 320 is at least 15% of the size of a payload associated with reporting the raw received SRS. The MSE of channel estimation may be below a threshold (e.g., negligible) if the size of the payload of the SRS report 320 is at least 20% of the size of a payload associated with reporting the raw received SRS. Accordingly, SRS compression may decrease the payload size by 80-85% without significantly decreasing throughput and increasing channel estimation MSE.

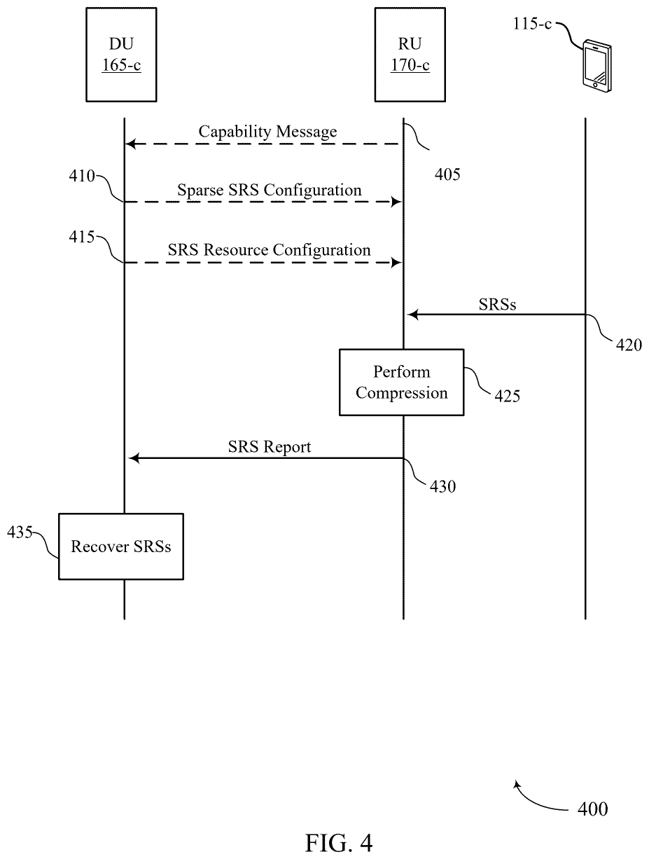

FIG. 4 shows an example of a process flow 400 that supports SRS compression techniques for SRS reporting in accordance with one or more aspects of the present disclosure. The process flow 400 may implement or may be implemented by aspects of the wireless communications system 100, the network architecture 200, or the wireless communications system 300. For example, the wireless communications system 300 may include one or more UEs 115 (e.g., a UE 115-c), a DU 165 (e.g., DU 165-c), and an RU 170 (e.g., an RU 170-c), which may be examples of the corresponding devices as described with reference to FIG. 1 and FIG. 2.

In the following description of the process flow 400, the operations between the UE 115-c, the RU 170-c, and the DU 165-c may occur in a different order than the example order shown and, in some examples, may be performed by one or more different devices other than those shown as examples. Some operations also may be omitted from the process flow 400, and other operations may be added to the process flow 400. Further, although some operations or signaling may be shown to occur at different times for discussion purposes, these operations may actually occur at the same time.

In some examples, at 405, the RU 170-c may output, to the DU 165-c, a capability message indicating one or more signal processing capabilities of the RU 170-c. For example, the one or more signal processing capabilities may include a capability of the RU 170-c to generate a compressed SRS (e.g., by performing a demapping procedure, a descrambling procedure, and an iFFT procedure on a set of received SRSs). The RU 170-c may output the capability message via a fronthaul link between the RU 170-c and the DU 165-c.

In some examples, at 410, the RU 170-c may obtain, from the DU 165-c, a control message configuring the RU 170-c to generate the compressed SRS. The DU 165-c may output the control message based on the capability message. For example, the DU 165-c may configure the RU 170-c to generate the compressed SRS if the RU 170-c is capable of performing the demapping procedure, descrambling procedure, and iFFT procedure. The control message may indicate for the RU 170-c to use a sparse SRS compression mode for outputting an SRS report. In some examples, the sparse SRS compression mode may have an iFFT size (e.g., an iFFT size for projecting the set of SRSs from a frequency-antenna domain representation to a delay-beam domain representation). In some examples, the sparse SRS compression mode may have a threshold power associated with one or more non-zero elements of the delay-beam domain representation. The RU 170-c may obtain the control message via the fronthaul link.

In some examples, at 415, the DU 165-c may output, to the RU 170-c, a control message indicating a SRS resource configuration. For example, the DU 165-c may indicate one or more SRS resources IDs, time domain resource positions, frequency domain resource positions, resource types, base sequences, and so on of the set of SRSs. The RU 170-c may accordingly identify one or more SRS resources that are activated or deactivated (e.g., based on the SRS resource ID). The SRS resource ID may be associated with an aperiodic trigger or a semi-persistent trigger. That is, the SRS resource ID may indicate whether the set of SRSs are aperiodic or semi-persistent. The RU 170-c may obtain the control message via the fronthaul link.

At 420, the RU 170-c may obtain the set of SRSs from one or more UEs 115 (e.g., the UE 115-c). The RU 170-c may obtain the SRSs based on the resource configuration. That is, the RU 170-c may obtain the SRSs via resources indicated by the SRS resource configuration and based on the resource type, the base sequence, and so on. The resource type of the SRSs may be periodic, aperiodic, or semi-persistent.

At 425, the RU 170-c may generate a compressed SRS based on obtaining the set of SRSs from the one or more UEs 115. For example, the RU 170-c may generate a sparse representation (e.g., a delay-beam domain representation) indicative of one or more of the set of SRSs (e.g., a frequency-antenna domain representation). The RU 170-c may generate the compressed SRS by performing a resource demapping of the one or more of the set of SRSs to obtain one or more groups of SRS resources and generating a projection of the one or more of the set of SRSs of reach group of the one or more groups. Generating the projection may include projecting each of the one or more SRSs from the frequency-antenna domain to the delay-beam domain (e.g., using the iFFT size indicated by the control message configuring the RU 170-c to generate the compressed SRS). The RU 170-c may generate the compressed SRS based on the signal processing capability of the RU 170-c to generate the compressed SRS and/or based on receiving the control message configuring the RU 170-c to generate the compressed SRS.

At 430, the RU 170-c may generate and output, to the DU 165-c, a SRS report indicating the compressed SRS. The RU 170-c may output the SRS report indicating the compressed SRS, one or more non-zero elements, and/or one or more delay-beam indices corresponding to the one or more non-zero elements. In some examples, the one or more non-zero elements may be elements of the compressed SRS with a power that satisfies the threshold power indicated via the control message indicating for the RU 170-c to generate the compressed SRS. For example, the RU 170-c may zero out one or more elements of the compressed SRS that do not satisfy the threshold power. The RU 170-c may output the report via the fronthaul link.

At 435, the DU 165-c may recover the one or more SRSs based on receiving the report. For example, the DU 165-c may generate a projection of the compressed SRS by projecting the compressed SRS from the delay-beam domain representation to the frequency-antenna domain representation.

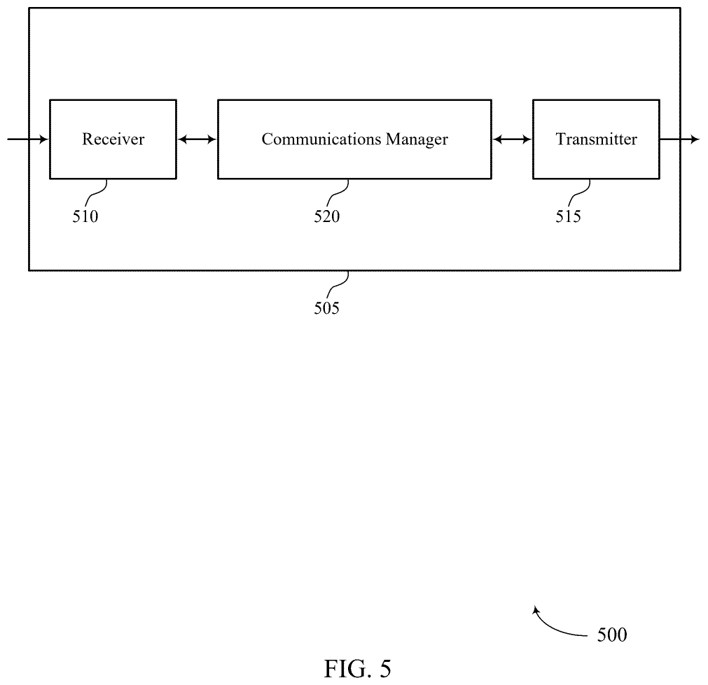

FIG. 5 shows a block diagram 500 of a device 505 that supports SRS compression techniques for SRS reporting in accordance with one or more aspects of the present disclosure. The device 505 may be an example of aspects of a network entity 105 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505. In some examples, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The transmitter 515 may provide a means for outputting (e.g., transmitting, providing, conveying, sending) information generated by other components of the device 505. For example, the transmitter 515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or any combination thereof. In some examples, the transmitter 515 and the receiver 510 may be co-located in a transceiver, which may include or be coupled with a modem.

The communications manager 520, the receiver 510, the transmitter 515, or various combinations or components thereof may be examples of means for performing various aspects of SRS compression techniques for SRS reporting as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for obtaining, from one or more UEs, a set of multiple SRSs. The communications manager 520 is capable of, configured to, or operable to support a means for generating a compressed SRS based on obtaining the set of multiple SRSs, the compressed SRS corresponding to a sparse representation that is indicative of one or more SRSs of the set of multiple SRSs. The communications manager 520 is capable of, configured to, or operable to support a means for outputting, to a DU, a SRS report indicating the compressed SRS.

Additionally, or alternatively, the communications manager 520 may support wireless communications in accordance with examples as disclosed herein. For example, the communications manager 520 is capable of, configured to, or operable to support a means for obtaining, from an RU, an SRS report indicating a compressed SRS, the compressed SRS corresponding to a sparse representation that is indicative of one or more SRSs. The communications manager 520 is capable of, configured to, or operable to support a means for recovering the one or more SRSs based on obtaining the compressed SRS.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for SRS compression, which may result in more efficient utilization of communication resources.

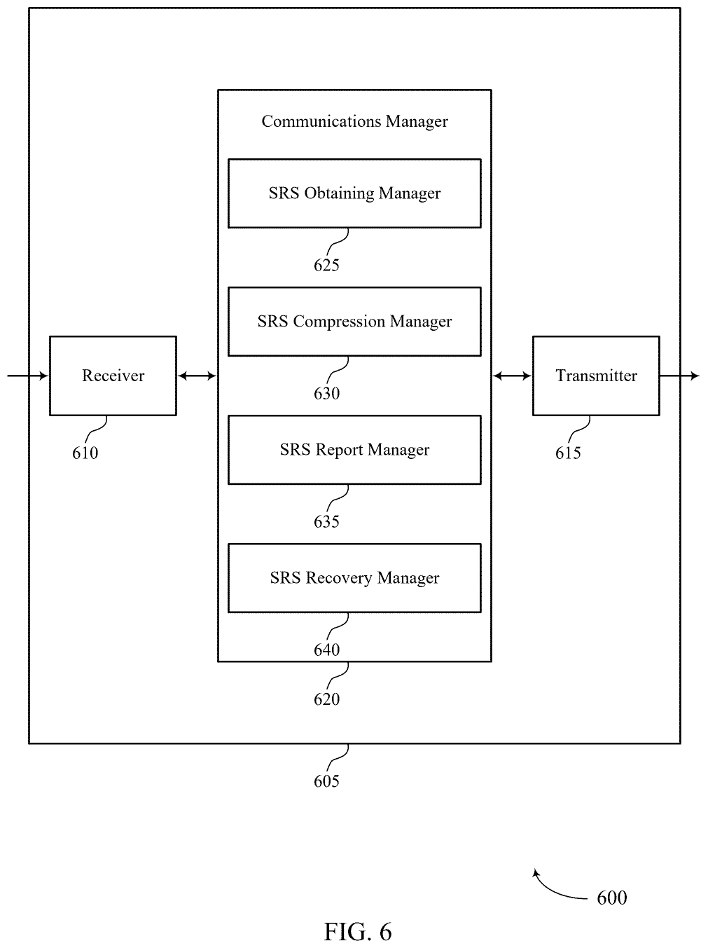

FIG. 6 shows a block diagram 600 of a device 605 that supports SRS compression techniques for SRS reporting in accordance with one or more aspects of the present disclosure. The device 605 may be an example of aspects of a device 505 or a network entity 105 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The device 605, or various components thereof, may be an example of means for performing various aspects of SRS compression techniques for SRS reporting as described herein. For example, the communications manager 620 may include an SRS obtaining manager 625, an SRS compression manager 630, an SRS report manager 635, an SRS recovery manager 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The SRS obtaining manager 625 is capable of, configured to, or operable to support a means for obtaining, from one or more UEs, a set of multiple SRSs. The SRS compression manager 630 is capable of, configured to, or operable to support a means for generating a compressed SRS based on obtaining the set of multiple SRSs, the compressed SRS corresponding to a sparse representation that is indicative of one or more SRSs of the set of multiple SRSs. The SRS report manager 635 is capable of, configured to, or operable to support a means for outputting, to a DU, a SRS report indicating the compressed SRS.

Additionally, or alternatively, the communications manager 620 may support wireless communications in accordance with examples as disclosed herein. The SRS report manager 635 is capable of, configured to, or operable to support a means for obtaining, from an RU, an SRS report indicating a compressed SRS, the compressed SRS corresponding to a sparse representation that is indicative of one or more SRSs. The SRS recovery manager 640 is capable of, configured to, or operable to support a means for recovering the one or more SRSs based on obtaining the compressed SRS.

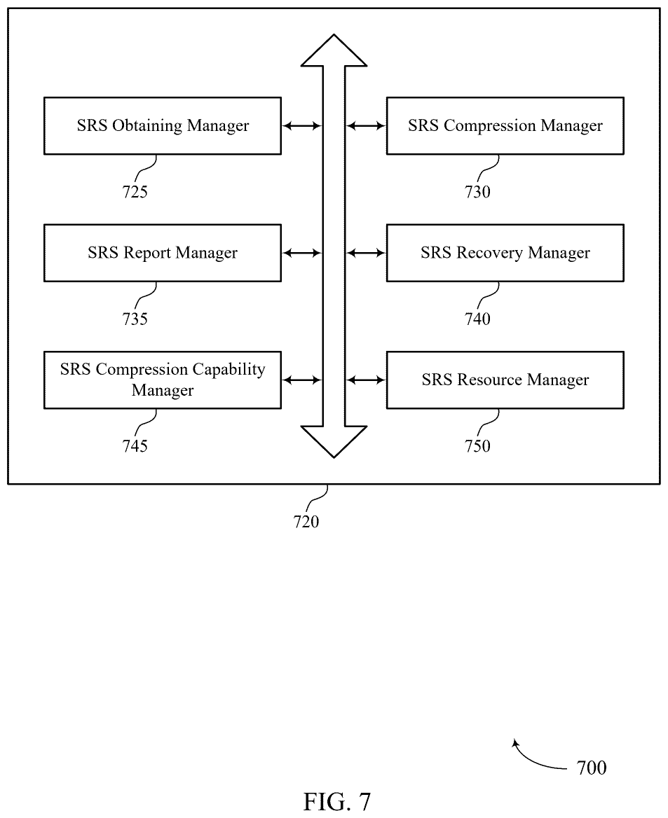

FIG. 7 shows a block diagram 700 of a communications manager 720 that supports SRS compression techniques for SRS reporting in accordance with one or more aspects of the present disclosure. The communications manager 720 may be an example of aspects of a communications manager 520, a communications manager 620, or both, as described herein. The communications manager 720, or various components thereof, may be an example of means for performing various aspects of SRS compression techniques for SRS reporting as described herein. For example, the communications manager 720 may include an SRS obtaining manager 725, an SRS compression manager 730, an SRS report manager 735, an SRS recovery manager 740, an SRS compression capability manager 745, an SRS resource manager 750, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 720 may support wireless communications in accordance with examples as disclosed herein. The SRS obtaining manager 725 is capable of, configured to, or operable to support a means for obtaining, from one or more UEs, a set of multiple SRSs. The SRS compression manager 730 is capable of, configured to, or operable to support a means for generating a compressed SRS based on obtaining the set of multiple SRSs, the compressed SRS corresponding to a sparse representation that is indicative of one or more SRSs of the set of multiple SRSs. The SRS report manager 735 is capable of, configured to, or operable to support a means for outputting, to a DU, a SRS report indicating the compressed SRS.

In some examples, to support generating the compressed SRS, the SRS compression manager 730 is capable of, configured to, or operable to support a means for applying a resource element demapping to the one or more SRSs of the set of multiple SRSs to obtain one or more groups of SRS resources. In some examples, to support generating the compressed SRS, the SRS compression manager 730 is capable of, configured to, or operable to support a means for generating a projection of the one or more SRSs for each group of the one or more groups, where generating the projection includes projecting each of the one or more SRSs from a frequency-antenna domain representation onto a delay-beam domain representation.

In some examples, the SRS compression capability manager 745 is capable of, configured to, or operable to support a means for outputting a capability message indicating one or more signal processing capabilities of the RU, where the one or more signal processing capabilities include a capability of the RU to perform a demapping procedure, a descrambling procedure, and an iFFT procedure on the one or more SRSs, where generating the compressed SRS is based on the one or more signal processing capabilities.

In some examples, the SRS compression manager 730 is capable of, configured to, or operable to support a means for obtaining a control message configuring the RU to generate the compressed SRS, where generating the compressed SRS is based on the control message.

In some examples, generating the compressed SRS is based on the one or more signal processing capabilities of the RU.

In some examples, the control message indicates that the RU use a sparse SRS compression mode for outputting the SRS report. In some examples, the sparse SRS compression mode is associated with an iFFT size for projecting the one or more SRSs from a frequency-antenna domain representation onto a delay-beam domain representation, a threshold associated with one or more near-zero elements of the delay-beam domain representation, or both.

In some examples, the SRS resource manager 750 is capable of, configured to, or operable to support a means for obtaining a control message indicating a SRS resource configuration, where obtaining the set of multiple SRSs is based on the SRS resource configuration.

In some examples, the SRS resource configuration includes an indication of a SRS resource identifier, a time domain resource position, a frequency domain resource position, a resource type, a base sequence, or any combination thereof.

In some examples, the SRS resource manager 750 is capable of, configured to, or operable to support a means for identifying one or more SRS resource that are activated or deactivated based on the SRS resource identifier, where the SRS resource identifier indicates whether the SRS resource configuration is associated with an aperiodic trigger or a semi-persistent trigger.

In some examples, the SRS report manager 735 is capable of, configured to, or operable to support a means for outputting, via the SRS report, an indication of one or more nonzero elements associated with the compressed SRS and an indication of a respective delay-beam index associated with each of the one or more nonzero elements.

Additionally, or alternatively, the communications manager 720 may support wireless communications in accordance with examples as disclosed herein. In some examples, the SRS report manager 735 is capable of, configured to, or operable to support a means for obtaining, from an RU, an SRS report indicating a compressed SRS, the compressed SRS corresponding to a sparse representation that is indicative of one or more SRSs. The SRS recovery manager 740 is capable of, configured to, or operable to support a means for recovering the one or more SRSs based on obtaining the compressed SRS.

In some examples, to support recovering the received SRS, the SRS recovery manager 740 is capable of, configured to, or operable to support a means for generating a projection of the compressed SRS, where generating the projection includes projecting the compressed SRS from a delay-beam domain representation onto a frequency-antenna domain representation.

In some examples, the SRS compression capability manager 745 is capable of, configured to, or operable to support a means for obtaining a capability message indicating one or more signal processing capabilities of the RU, where the one or more signal processing capabilities include a capability of the RU to perform a demapping procedure, a descrambling procedure, and an iFFT procedure on the one or more SRSs, where obtaining the SRS report indicating the compressed SRS is based on the one or more signal processing capabilities.

In some examples, the SRS compression manager 730 is capable of, configured to, or operable to support a means for outputting a control message configuring the RU to generate the compressed SRS, where obtaining the SRS report indicating the compressed SRS is based on the control message.

In some examples, the compressed SRS is based on the one or more signal processing capabilities.

In some examples, the control message indicates that the RU use a sparse SRS compression mode for outputting the SRS report. In some examples, the sparse reference signal compression mode (e.g., sparse SRS compression mode) is associated with an iFFT size for projecting the one or more SRSs from a frequency-antenna domain representation onto a delay-beam domain representation, a threshold associated with one or more near-zero elements of the delay-beam domain representation, or both.

In some examples, the SRS resource manager 750 is capable of, configured to, or operable to support a means for outputting a control message indicating a SRS resource configuration, where obtaining the SRS report indicating the compressed SRS is based on the control message.

In some examples, the SRS resource configuration includes an indication of a SRS resource identifier, a time domain resource position, a frequency domain resource position, a resource type, a base sequence, or any combination thereof.

In some examples, one or more SRS resource that are activated or deactivated are indicated by the SRS resource identifier. In some examples, the SRS resource identifier indicates whether the SRS resource configuration is associated with an aperiodic trigger or a semi-persistent trigger.

In some examples, the SRS report manager 735 is capable of, configured to, or operable to support a means for obtaining, via the SRS report, an indication of one or more nonzero elements associated with the compressed SRS and an indication of a respective delay-beam index associated with each of the one or more nonzero elements.

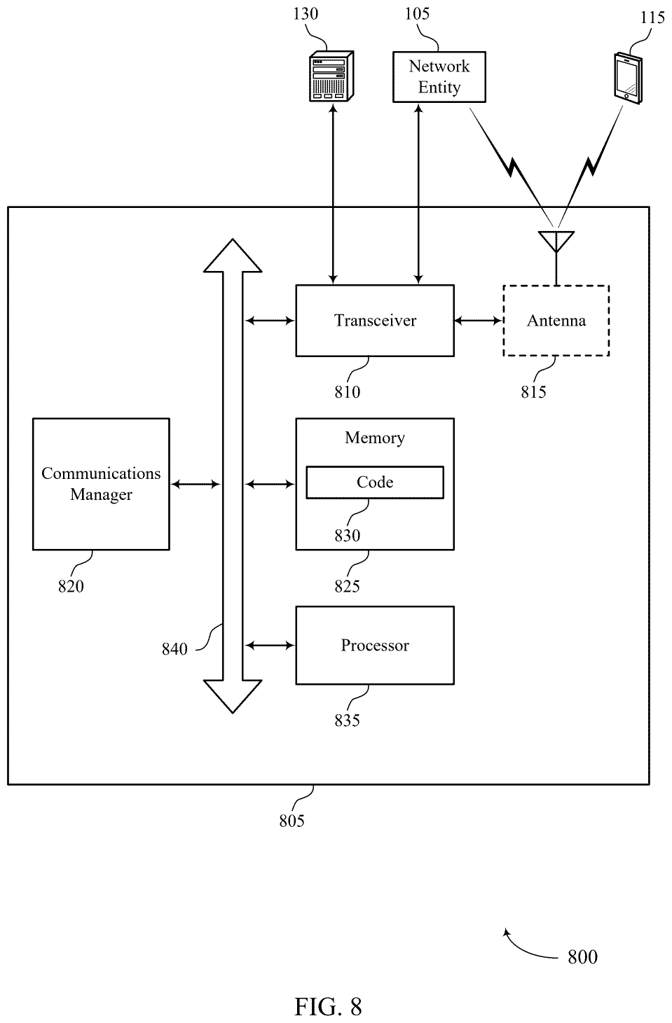

FIG. 8 shows a diagram of a system 800 including a device 805 that supports SRS compression techniques for SRS reporting in accordance with one or more aspects of the present disclosure. The device 805 may be an example of or include components of a device 505, a device 605, or a network entity 105 as described herein. The device 805 may communicate with other network devices or network equipment such as one or more of the network entities 105, UEs 115, or any combination thereof. The communications may include communications over one or more wired interfaces, over one or more wireless interfaces, or any combination thereof. The device 805 may include components that support outputting and obtaining communications, such as a communications manager 820, a transceiver 810, one or more antennas 815, at least one memory 825, code 830, and at least one processor 835. These components may be in electronic communication or otherwise coupled (e.g., operatively, communicatively, functionally, electronically, electrically) via one or more buses (e.g., a bus 840).

The transceiver 810 may support bi-directional communications via wired links, wireless links, or both as described herein. In some examples, the transceiver 810 may include a wired transceiver and may communicate bi-directionally with another wired transceiver. Additionally, or alternatively, in some examples, the transceiver 810 may include a wireless transceiver and may communicate bi-directionally with another wireless transceiver. In some examples, the device 805 may include one or more antennas 815, which may be capable of transmitting or receiving wireless transmissions (e.g., concurrently). The transceiver 810 may also include a modem to modulate signals, to provide the modulated signals for transmission (e.g., by one or more antennas 815, by a wired transmitter), to receive modulated signals (e.g., from one or more antennas 815, from a wired receiver), and to demodulate signals. In some implementations, the transceiver 810 may include one or more interfaces, such as one or more interfaces coupled with the one or more antennas 815 that are configured to support various receiving or obtaining operations, or one or more interfaces coupled with the one or more antennas 815 that are configured to support various transmitting or outputting operations, or a combination thereof. In some implementations, the transceiver 810 may include or be configured for coupling with one or more processors or one or more memory components that are operable to perform or support operations based on received or obtained information or signals, or to generate information or other signals for transmission or other outputting, or any combination thereof. In some implementations, the transceiver 810, or the transceiver 810 and the one or more antennas 815, or the transceiver 810 and the one or more antennas 815 and one or more processors or one or more memory components (e.g., the at least one processor 835, the at least one memory 825, or both), may be included in a chip or chip assembly that is installed in the device 805. In some examples, the transceiver 810 may be operable to support communications via one or more communications links (e.g., communication link(s) 125, backhaul communication link(s) 120, a midhaul communication link 162, a fronthaul communication link 168).

The at least one memory 825 may include RAM, ROM, or any combination thereof. The at least one memory 825 may store computer-readable, computer-executable, or processor-executable code, such as the code 830. The code 830 may include instructions that, when executed by one or more of the at least one processor 835, cause the device 805 to perform various functions described herein. The code 830 may be stored in a non-transitory computer-readable medium such as system memory or another type of memory. In some cases, the code 830 may not be directly executable by a processor of the at least one processor 835 but may cause a computer (e.g., when compiled and executed) to perform functions described herein. In some cases, the at least one memory 825 may include, among other things, a BIOS which may control basic hardware or software operation such as the interaction with peripheral components or devices. In some examples, the at least one processor 835 may include multiple processors and the at least one memory 825 may include multiple memories. One or more of the multiple processors may be coupled with one or more of the multiple memories which may, individually or collectively, be configured to perform various functions herein (for example, as part of a processing system).

The at least one processor 835 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 835 may be configured to operate a memory array using a memory controller. In some other cases, a memory controller may be integrated into one or more of the at least one processor 835. The at least one processor 835 may be configured to execute computer-readable instructions stored in a memory (e.g., one or more of the at least one memory 825) to cause the device 805 to perform various functions (e.g., functions or tasks supporting SRS compression techniques for SRS reporting). For example, the device 805 or a component of the device 805 may include at least one processor 835 and at least one memory 825 coupled with one or more of the at least one processor 835, the at least one processor 835 and the at least one memory 825 configured to perform various functions described herein. The at least one processor 835 may be an example of a cloud-computing platform (e.g., one or more physical nodes and supporting software such as operating systems, virtual machines, or container instances) that may host the functions (e.g., by executing code 830) to perform the functions of the device 805. The at least one processor 835 may be any one or more suitable processors capable of executing scripts or instructions of one or more software programs stored in the device 805 (such as within one or more of the at least one memory 825).

In some examples, the at least one processor 835 may include multiple processors and the at least one memory 825 may include multiple memories. One or more of the multiple processors may be coupled with one or more of the multiple memories, which may, individually or collectively, be configured to perform various functions herein. In some examples, the at least one processor 835 may be a component of a processing system, which may refer to a system (such as a series) of machines, circuitry (including, for example, one or both of processor circuitry (which may include the at least one processor 835) and memory circuitry (which may include the at least one memory 825)), or components, that receives or obtains inputs and processes the inputs to produce, generate, or obtain a set of outputs. The processing system may be configured to perform one or more of the functions described herein. For example, the at least one processor 835 or a processing system including the at least one processor 835 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 825 or otherwise, to perform one or more of the functions described herein.

In some examples, a bus 840 may support communications of (e.g., within) a protocol layer of a protocol stack. In some examples, a bus 840 may support communications associated with a logical channel of a protocol stack (e.g., between protocol layers of a protocol stack), which may include communications performed within a component of the device 805, or between different components of the device 805 that may be co-located or located in different locations (e.g., where the device 805 may refer to a system in which one or more of the communications manager 820, the transceiver 810, the at least one memory 825, the code 830, and the at least one processor 835 may be located in one of the different components or divided between different components).

In some examples, the communications manager 820 may manage aspects of communications with a core network 130 (e.g., via one or more wired or wireless backhaul links). For example, the communications manager 820 may manage the transfer of data communications for client devices, such as one or more UEs 115. In some examples, the communications manager 820 may manage communications with one or more other network entities 105, and may include a controller or scheduler for controlling communications with UEs 115 (e.g., in cooperation with the one or more other network devices). In some examples, the communications manager 820 may support an X2 interface within an LTE/LTE-A wireless communications network technology to provide communication between network entities 105.

The communications manager 820 may support wireless communications in accordance with examples as disclosed herein. For example, the communications manager 820 is capable of, configured to, or operable to support a means for obtaining, from one or more UEs, a set of multiple SRSs. The communications manager 820 is capable of, configured to, or operable to support a means for generating a compressed SRS based on obtaining the set of multiple SRSs, the compressed SRS corresponding to a sparse representation that is indicative of one or more SRSs of the set of multiple SRSs. The communications manager 820 is capable of, configured to, or operable to support a means for outputting, to a DU, a SRS report indicating the compressed SRS.

Additionally, or alternatively, the communications manager 820 may support wireless communications in accordance with examples as disclosed herein. For example, the communications manager 820 is capable of, configured to, or operable to support a means for obtaining, from an RU, an SRS report indicating a compressed SRS, the compressed SRS corresponding to a sparse representation that is indicative of one or more SRSs. The communications manager 820 is capable of, configured to, or operable to support a means for recovering the one or more SRSs based on obtaining the compressed SRS.

By including or configuring the communications manager 820 in accordance with examples as described herein, the device 805 may support techniques for SRS compression, which may result in reduced latency, more efficient utilization of communication resources, and improved coordination between devices.

In some examples, the communications manager 820 may be configured to perform various operations (e.g., receiving, obtaining, monitoring, outputting, transmitting) using or otherwise in cooperation with the transceiver 810, the one or more antennas 815 (e.g., where applicable), or any combination thereof. Although the communications manager 820 is illustrated as a separate component, in some examples, one or more functions described with reference to the communications manager 820 may be supported by or performed by the transceiver 810, one or more of the at least one processor 835, one or more of the at least one memory 825, the code 830, or any combination thereof (for example, by a processing system including at least a portion of the at least one processor 835, the at least one memory 825, the code 830, or any combination thereof). For example, the code 830 may include instructions executable by one or more of the at least one processor 835 to cause the device 805 to perform various aspects of SRS compression techniques for SRS reporting as described herein, or the at least one processor 835 and the at least one memory 825 may be otherwise configured to, individually or collectively, perform or support such operations.

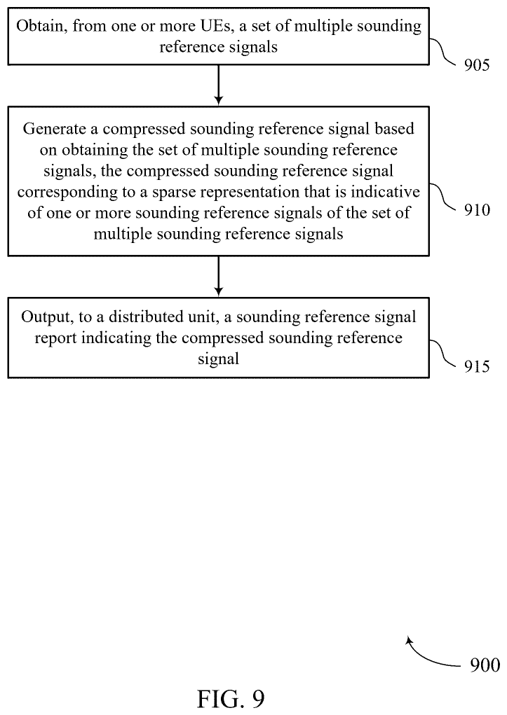

FIG. 9 shows a flowchart illustrating a method 900 that supports SRS compression techniques for SRS reporting in accordance with one or more aspects of the present disclosure. The operations of the method 900 may be implemented by a network entity or its components as described herein. For example, the operations of the method 900 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 905, the method may include obtaining, from one or more UEs, a set of multiple SRSs. The operations of 905 may be performed in accordance with examples as disclosed herein. In some examples, aspects of the operations of 905 may be performed by an SRS obtaining manager 725 as described with reference to FIG. 7.

At 910, the method may include generating a compressed SRS based on obtaining the set of multiple SRSs, the compressed SRS corresponding to a sparse representation that is indicative of one or more SRSs of the set of multiple SRSs. The operations of 910 may be performed in accordance with examples as disclosed herein. In some examples, aspects of the operations of 910 may be performed by an SRS compression manager 730 as described with reference to FIG. 7.

At 915, the method may include outputting, to a DU, a SRS report indicating the compressed SRS. The operations of 915 may be performed in accordance with examples as disclosed herein. In some examples, aspects of the operations of 915 may be performed by an SRS report manager 735 as described with reference to FIG. 7.

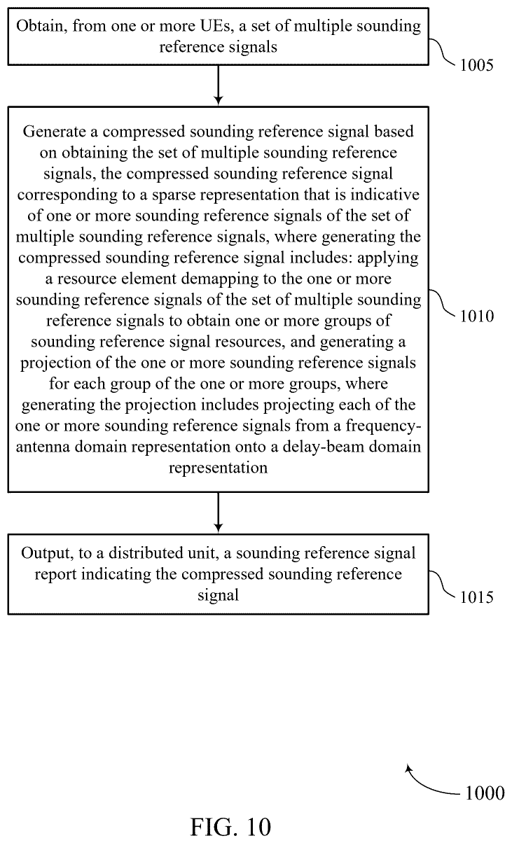

FIG. 10 shows a flowchart illustrating a method 1000 that supports SRS compression techniques for SRS reporting in accordance with one or more aspects of the present disclosure. The operations of the method 1000 may be implemented by a network entity or its components as described herein. For example, the operations of the method 1000 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1005, the method may include obtaining, from one or more UEs, a set of multiple SRSs. The operations of 1005 may be performed in accordance with examples as disclosed herein. In some examples, aspects of the operations of 1005 may be performed by an SRS obtaining manager 725 as described with reference to FIG. 7.

At 1010, the method may include generating a compressed SRS based on obtaining the set of multiple SRSs, the compressed SRS corresponding to a sparse representation that is indicative of one or more SRSs of the set of multiple SRSs. In some examples, to generate the compressed SRS, the method may include applying a resource element demapping to the one or more SRSs of the set of multiple SRSs to obtain one or more groups of SRS resources and generating a projection of the one or more SRSs for each group of the one or more groups, where generating the projection includes projecting each of the one or more SRSs from a frequency-antenna domain representation onto a delay-beam domain representation. The operations of 1010 may be performed in accordance with examples as disclosed herein. In some examples, aspects of the operations of 1010 may be performed by an SRS compression manager 730 as described with reference to FIG. 7.

At 1015, the method may include outputting, to a DU, a SRS report indicating the compressed SRS. The operations of 1015 may be performed in accordance with examples as disclosed herein. In some examples, aspects of the operations of 1015 may be performed by an SRS report manager 735 as described with reference to FIG. 7.

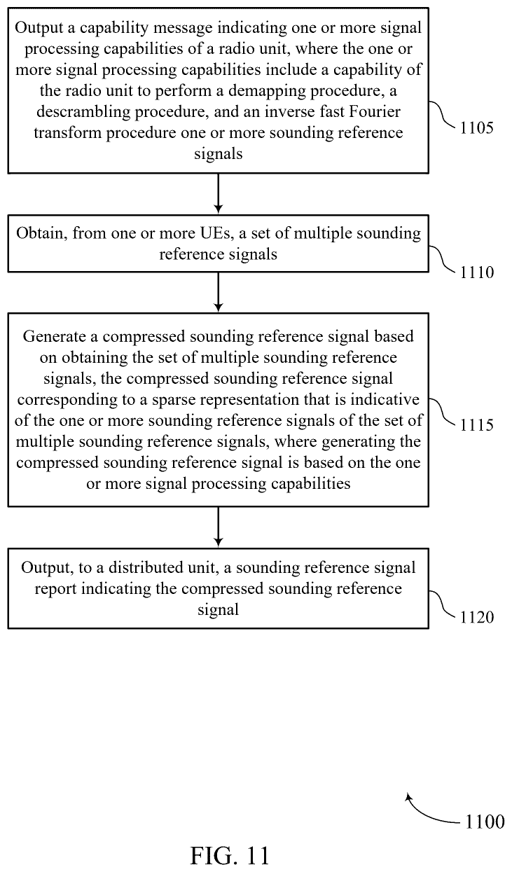

FIG. 11 shows a flowchart illustrating a method 1100 that supports SRS compression techniques for SRS reporting in accordance with one or more aspects of the present disclosure. The operations of the method 1100 may be implemented by a network entity or its components as described herein. For example, the operations of the method 1100 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1105, the method may include outputting a capability message indicating one or more signal processing capabilities of an RU, where the one or more signal processing capabilities include a capability of the RU to perform a demapping procedure, a descrambling procedure, and an iFFT procedure on one or more SRSs. The operations of 1105 may be performed in accordance with examples as disclosed herein. In some examples, aspects of the operations of 1105 may be performed by an SRS compression capability manager 745 as described with reference to FIG. 7.

At 1110, the method may include obtaining, from one or more UEs, a set of multiple SRSs. The operations of 1110 may be performed in accordance with examples as disclosed herein. In some examples, aspects of the operations of 1110 may be performed by an SRS obtaining manager 725 as described with reference to FIG. 7.

At 1115, the method may include generating the compressed SRS based on obtaining the set of multiple SRSs, the compressed SRS corresponding to a sparse representation that is indicative of the one or more SRSs of the set of multiple SRSs, where generating the compressed SRS is based on the one or more signal processing capabilities. The operations of 1115 may be performed in accordance with examples as disclosed herein. In some examples, aspects of the operations of 1115 may be performed by an SRS compression manager 730 as described with reference to FIG. 7.

At 1120, the method may include outputting, to a DU, a SRS report indicating the compressed SRS. The operations of 1120 may be performed in accordance with examples as disclosed herein. In some examples, aspects of the operations of 1120 may be performed by an SRS report manager 735 as described with reference to FIG. 7.

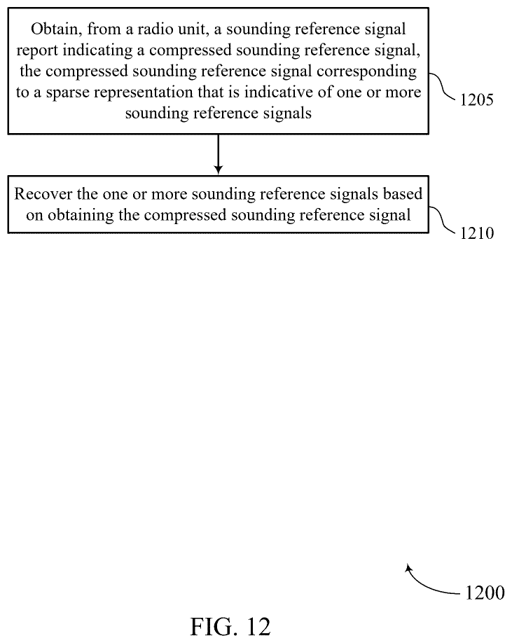

FIG. 12 shows a flowchart illustrating a method 1200 that supports SRS compression techniques for SRS reporting in accordance with one or more aspects of the present disclosure. The operations of the method 1200 may be implemented by a network entity or its components as described herein. For example, the operations of the method 1200 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1205, the method may include obtaining, from an RU, an SRS report indicating a compressed SRS, the compressed SRS corresponding to a sparse representation that is indicative of one or more SRSs. The operations of 1205 may be performed in accordance with examples as disclosed herein. In some examples, aspects of the operations of 1205 may be performed by an SRS report manager 735 as described with reference to FIG. 7.

At 1210, the method may include recovering the one or more SRSs based on obtaining the compressed SRS. The operations of 1210 may be performed in accordance with examples as disclosed herein. In some examples, aspects of the operations of 1210 may be performed by an SRS recovery manager 740 as described with reference to FIG. 7.

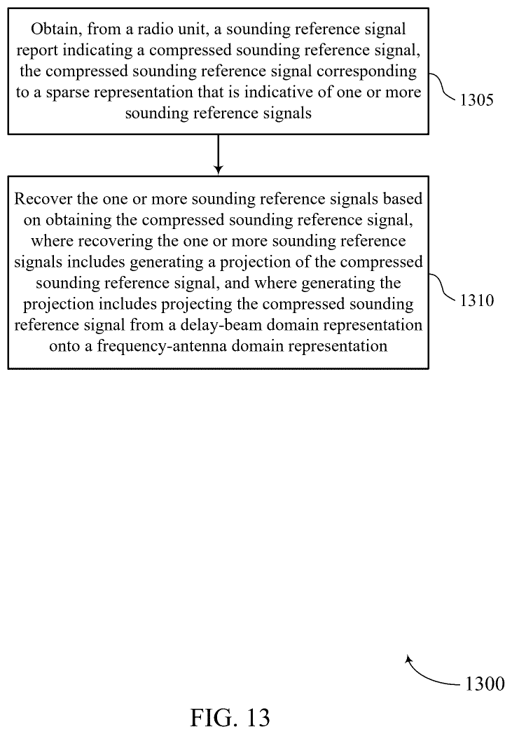

FIG. 13 shows a flowchart illustrating a method 1300 that supports SRS compression techniques for SRS reporting in accordance with one or more aspects of the present disclosure. The operations of the method 1300 may be implemented by a network entity or its components as described herein. For example, the operations of the method 1300 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1305, the method may include obtaining, from an RU, an SRS report indicating a compressed SRS, the compressed SRS corresponding to a sparse representation that is indicative of one or more SRSs. The operations of 1305 may be performed in accordance with examples as disclosed herein. In some examples, aspects of the operations of 1305 may be performed by an SRS report manager 735 as described with reference to FIG. 7.

At 1310, the method may include recovering the one or more SRSs based on obtaining the compressed SRS. In some examples, to recover the one or more SRSs, the method may include generating a projection of the compressed SRS, where generating the projection includes projecting the compressed SRS from a delay-beam domain representation onto a frequency-antenna domain representation. The operations of 1310 may be performed in accordance with examples as disclosed herein. In some examples, aspects of the operations of 1310 may be performed by an SRS recovery manager 740 as described with reference to FIG. 7.

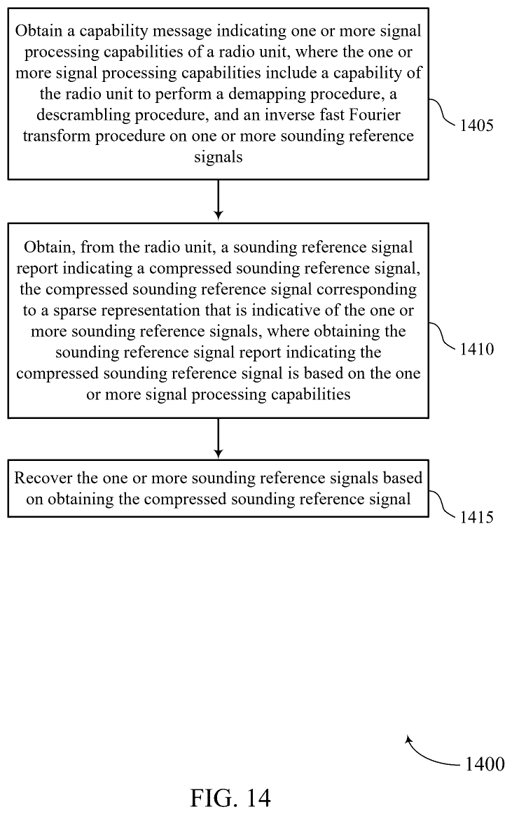

FIG. 14 shows a flowchart illustrating a method 1400 that supports SRS compression techniques for SRS reporting in accordance with one or more aspects of the present disclosure. The operations of the method 1400 may be implemented by a network entity or its components as described herein. For example, the operations of the method 1400 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1405, the method may include obtaining a capability message indicating one or more signal processing capabilities of an RU, where the one or more signal processing capabilities include a capability of the RU to perform a demapping procedure, a descrambling procedure, and an iFFT procedure on one or more SRSs. The operations of 1405 may be performed in accordance with examples as disclosed herein. In some examples, aspects of the operations of 1405 may be performed by an SRS compression capability manager 745 as described with reference to FIG. 7.

At 1410, the method may include obtaining, from the RU, an SRS report indicating a compressed SRS, the compressed SRS corresponding to a sparse representation that is indicative of the one or more SRSs, where obtaining the SRS report indicating the compressed SRS is based on the one or more signal processing capabilities. The operations of 1410 may be performed in accordance with examples as disclosed herein. In some examples, aspects of the operations of 1410 may be performed by an SRS report manager 735 as described with reference to FIG. 7.

At 1415, the method may include recovering the one or more SRSs based on obtaining the compressed SRS. The operations of 1415 may be performed in accordance with examples as disclosed herein. In some examples, aspects of the operations of 1415 may be performed by an SRS recovery manager 740 as described with reference to FIG. 7.

The following provides an overview of aspects of the present disclosure:

Aspect 1: A method for wireless communications by an RU, comprising: obtaining, from one or more UEs, a plurality of SRSs; generating a compressed SRS based at least in part on obtaining the plurality of SRSs, the compressed SRS corresponding to a sparse representation that is indicative of one or more SRSs of the plurality of SRSs; and outputting, to a DU, a SRS report indicating the compressed SRS.

Aspect 2: The method of aspect 1, wherein generating the compressed SRS comprises: applying a RE demapping to the one or more SRSs of the plurality of SRSs to obtain one or more groups of SRS resources; and generating a projection of the one or more SRSs for each group of the one or more groups, wherein generating the projection comprises projecting each of the one or more SRSs from a frequency-antenna domain representation onto a delay-beam domain representation.

Aspect 3: The method of any of aspects 1 through 2, further comprising: outputting a capability message indicating one or more signal processing capabilities of the RU, wherein the one or more signal processing capabilities comprise a capability of the RU to perform a demapping procedure, a descrambling procedure, and an iFFT procedure on the one or more sounding references signals, wherein generating the compressed SRS is based at least in part on the one or more signal processing capabilities.

Aspect 4: The method of any of aspects 1 through 3, further comprising: obtaining a control message configuring the RU to generate the compressed SRS, wherein generating the compressed SRS is based at least in part on the control message.

Aspect 5: The method of aspect 4, wherein generating the compressed SRS is based at least in part on the one or more signal processing capabilities of the RU.

Aspect 6: The method of any of aspects 4 through 5, wherein the control message indicates that the RU use a sparse SRS compression mode for outputting the SRS report, the sparse SRS compression mode is associated with an iFFT size for projecting the one or more SRSs from a frequency-antenna domain representation onto a delay-beam domain representation, a threshold associated with one or more near-zero elements of the delay-beam domain representation, or both.

Aspect 7: The method of any of aspects 1 through 6, further comprising: obtaining a control message indicating a SRS resource configuration, wherein obtaining the plurality of SRSs is based at least in part on the SRS resource configuration.

Aspect 8: The method of aspect 7, wherein the SRS resource configuration comprises an indication of a SRS resource ID, a time domain resource position, a frequency domain resource position, a resource type, a base sequence, or any combination thereof.

Aspect 9: The method of aspect 8, further comprising: identifying one or more SRS resource that are activated or deactivated based at least in part on the SRS resource ID, wherein the SRS resource ID indicates whether the SRS resource configuration is associated with an aperiodic trigger or a semi-persistent trigger.

Aspect 10: The method of any of aspects 1 through 9, further comprising: outputting, via the SRS report, an indication of one or more nonzero elements associated with the compressed SRS and an indication of a respective delay-beam index associated with each of the one or more nonzero elements.

Aspect 11: A method for wireless communications by a DU, comprising: obtaining, from an RU, an SRS report indicating a compressed SRS, the compressed SRS corresponding to a sparse representation that is indicative of one or more SRSs; and recovering the one or more SRSs based at least in part on obtaining the compressed SRS.

Aspect 12: The method of aspect 11, wherein recovering the received SRS comprises: generating a projection of the compressed SRS, wherein generating the projection comprises projecting the compressed SRS from a delay-beam domain representation onto a frequency-antenna domain representation.

Aspect 13: The method of any of aspects 11 through 12, further comprising: obtaining a capability message indicating one or more signal processing capabilities of the RU, wherein the one or more signal processing capabilities comprise a capability of the RU to perform a demapping procedure, a descrambling procedure, and an iFFT procedure on the one or more sounding references signals, wherein obtaining the SRS report indicating the compressed SRS is based at least in part on the one or more signal processing capabilities.

Aspect 14: The method of any of aspects 11 through 13, further comprising: outputting a control message configuring the RU to generate the compressed SRS, wherein obtaining the SRS report indicating the compressed SRS is based at least in part on the control message.

Aspect 15: The method of aspect 14, wherein the compressed SRS is based at least in part on the one or more signal processing capabilities.

Aspect 16: The method of any of aspects 14 through 15, wherein the control message indicates that the RU use a sparse SRS compression mode for outputting the SRS report, the sparse SRS compression mode is associated with an iFFT size for projecting the one or more SRSs from a frequency-antenna domain representation onto a delay-beam domain representation, a threshold associated with one or more near-zero elements of the delay-beam domain representation, or both.

Aspect 17: The method of any of aspects 11 through 16, further comprising: outputting a control message indicating a SRS resource configuration, wherein obtaining the SRS report indicating the compressed SRS is based at least in part on the control message

Aspect 18: The method of aspect 17, wherein the SRS resource configuration comprises an indication of a SRS resource ID, a time domain resource position, a frequency domain resource position, a resource type, a base sequence, or any combination thereof.

Aspect 19: The method of aspect 18, wherein one or more SRS resource that are activated or deactivated are indicated by the SRS resource ID, and the SRS resource ID indicates whether the SRS resource configuration is associated with an aperiodic trigger or a semi-persistent trigger.

Aspect 20: The method of any of aspects 11 through 19, further comprising: obtaining, via the SRS report, an indication of one or more nonzero elements associated with the compressed SRS and an indication of a respective delay-beam index associated with each of the one or more nonzero elements.

Aspect 21: An RU for wireless communications, comprising one or more memories storing processor-executable code, and one or more processors coupled with the one or more memories and individually or collectively operable to execute the code to cause the RU to perform a method of any of aspects 1 through 10.

Aspect 22: An RU for wireless communications, comprising at least one means for performing a method of any of aspects 1 through 10.

Aspect 23: A non-transitory computer-readable medium storing code for wireless communications, the code comprising instructions executable by one or more processors to perform a method of any of aspects 1 through 10.

Aspect 24: A DU for wireless communications, comprising one or more memories storing processor-executable code, and one or more processors coupled with the one or more memories and individually or collectively operable to execute the code to cause the DU to perform a method of any of aspects 11 through 20.

Aspect 25: A DU for wireless communications, comprising at least one means for performing a method of any of aspects 11 through 20.

Aspect 26: A non-transitory computer-readable medium storing code for wireless communications, the code comprising instructions executable by one or more processors to perform a method of any of aspects 11 through 20.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A radio unit (RU), comprising:
one or more memories storing processor-executable code; and
one or more processors coupled with the one or more memories and individually or collectively operable to execute the code to cause the RU to:
obtain, from one or more user equipments (UEs), a plurality of sounding reference signals;
generate a compressed sounding reference signal based at least in part on obtaining the plurality of sounding reference signals, the compressed sounding reference signal corresponding to a sparse representation that is indicative of one or more sounding reference signals of the plurality of sounding reference signals; and
output, to a distributed unit (DU), a sounding reference signal report indicating the compressed sounding reference signal.

2. The RU of claim 1, wherein, to generate the compressed sounding reference signal, the one or more processors are individually or collectively operable to execute the code to cause the RU to:
apply a resource element demapping to the one or more sounding reference signals of the plurality of sounding reference signals to obtain one or more groups of sounding reference signal resources; and
generate a projection of the one or more sounding reference signals for each group of the one or more groups, wherein generating the projection comprises projecting each of the one or more sounding reference signals from a frequency-antenna domain representation onto a delay-beam domain representation.

3. The RU of claim 1, wherein the one or more processors are individually or collectively further operable to execute the code to cause the RU to:
output a capability message indicating one or more signal processing capabilities of the RU, wherein the one or more signal processing capabilities comprise a capability of the RU to perform a demapping procedure, a descrambling procedure, and an inverse fast Fourier transform procedure on the one or more sounding reference signals, wherein generating the compressed sounding reference signal is based at least in part on the one or more signal processing capabilities.

4. The RU of claim 1, wherein the one or more processors are individually or collectively further operable to execute the code to cause the RU to:
obtain a control message configuring the RU to generate the compressed sounding reference signal, wherein generating the compressed sounding reference signal is based at least in part on the control message.

5. The RU of claim 4, wherein generating the compressed sounding reference signal is based at least in part on one or more signal processing capabilities of the RU.

6. The RU of claim 4, wherein the control message indicates that the RU use a sparse sounding reference signal compression mode for outputting the sounding reference signal report, and wherein the sparse sounding reference signal compression mode is associated with an inverse fast Fourier transform size for projecting the one or more sounding reference signals from a frequency-antenna domain representation onto a delay-beam domain representation, a threshold associated with one or more near-zero elements of the delay-beam domain representation, or both.

7. The RU of claim 1, wherein the one or more processors are individually or collectively further operable to execute the code to cause the RU to:
obtain a control message indicating a sounding reference signal resource configuration, wherein obtaining the plurality of sounding reference signals is based at least in part on the sounding reference signal resource configuration.

8. The RU of claim 7, wherein the sounding reference signal resource configuration comprises an indication of a sounding reference signal resource identifier, a time domain resource position, a frequency domain resource position, a resource type, a base sequence, or any combination thereof.

9. The RU of claim 8, wherein the one or more processors are individually or collectively further operable to execute the code to cause the RU to:
identify one or more sounding reference signal resource that are activated or deactivated based at least in part on the sounding reference signal resource identifier, wherein the sounding reference signal resource identifier indicates whether the sounding reference signal resource configuration is associated with an aperiodic trigger or a semi-persistent trigger.

10. The RU of claim 1, wherein the one or more processors are individually or collectively further operable to execute the code to cause the RU to:
output, via the sounding reference signal report, an indication of one or more nonzero elements associated with the compressed sounding reference signal and an indication of a respective delay-beam index associated with each of the one or more nonzero elements.

11. A distributed unit (DU), comprising:
one or more memories storing processor-executable code; and
one or more processors coupled with the one or more memories and individually or collectively operable to execute the code to cause the distributed unit (DU) to:
obtain, from a radio unit (RU), a sounding reference signal report indicating a compressed sounding reference signal, the compressed sounding reference signal corresponding to a sparse representation that is indicative of one or more sounding reference signals; and
recover the one or more sounding reference signals based at least in part on obtaining the compressed sounding reference signal.

12. The DU of claim 11, wherein, to recover the one or more sounding reference signals, the one or more processors are individually or collectively operable to execute the code to cause the DU to:
generate a projection of the compressed sounding reference signal, wherein generating the projection comprises projecting the compressed sounding reference signal from a delay-beam domain representation onto a frequency-antenna domain representation.

13. The DU of claim 11, wherein the one or more processors are individually or collectively further operable to execute the code to cause the DU to:
obtain a capability message indicating one or more signal processing capabilities of the RU, wherein the one or more signal processing capabilities comprise a capability of the RU to perform a demapping procedure, a descrambling procedure, and an inverse fast Fourier transform procedure on the one or more sounding reference signals, wherein obtaining the sounding reference signal report indicating the compressed sounding reference signal is based at least in part on the one or more signal processing capabilities.

14. The DU of claim 11, wherein the one or more processors are individually or collectively further operable to execute the code to cause the DU to:
output a control message configuring the RU to generate the compressed sounding reference signal, wherein obtaining the sounding reference signal report indicating the compressed sounding reference signal is based at least in part on the control message.

15. The DU of claim 14, wherein the compressed sounding reference signal is based at least in part on one or more signal processing capabilities.

16. The DU of claim 14, wherein:
the control message indicates that the RU use a sparse sounding reference signal compression mode for outputting the sounding reference signal report, and
the sparse sounding reference signal compression mode is associated with an inverse fast Fourier transform size for projecting the one or more sounding reference signals from a frequency-antenna domain representation onto a delay-beam domain representation, a threshold associated with one or more near-zero elements of the delay-beam domain representation, or both.

17. The DU of claim 11, wherein the one or more processors are individually or collectively further operable to execute the code to cause the DU to:
output a control message indicating a sounding reference signal resource configuration, wherein obtaining the sounding reference signal report indicating the compressed sounding reference signal is based at least in part on the control message.

18. The DU of claim 17, wherein the sounding reference signal resource configuration comprises an indication of a sounding reference signal resource identifier, a time domain resource position, a frequency domain resource position, a resource type, a base sequence, or any combination thereof.

19. The DU of claim 18, wherein:
one or more sounding reference signal resource that are activated or deactivated are indicated by the sounding reference signal resource identifier, and
the sounding reference signal resource identifier indicates whether the sounding reference signal resource configuration is associated with an aperiodic trigger or a semi-persistent trigger.

20. The DU of claim 11, wherein the one or more processors are individually or collectively further operable to execute the code to cause the DU to:
obtain, via the sounding reference signal report, an indication of one or more nonzero elements associated with the compressed sounding reference signal and an indication of a respective delay-beam index associated with each of the one or more nonzero elements.

21. A method for wireless communications by a radio unit (RU), comprising:
obtaining, from one or more user equipments (UEs), a plurality of sounding reference signals;
generating a compressed sounding reference signal based at least in part on obtaining the plurality of sounding reference signals, the compressed sounding reference signal corresponding to a sparse representation that is indicative of one or more sounding reference signals of the plurality of sounding reference signals; and
outputting, to a distributed unit (DU), a sounding reference signal report indicating the compressed sounding reference signal.

22. The method of claim 21, wherein generating the compressed sounding reference signal comprises:
applying a resource element demapping to the one or more sounding reference signals of the plurality of sounding reference signals to obtain one or more groups of sounding reference signal resources; and
generating a projection of the one or more sounding reference signals for each group of the one or more groups, wherein generating the projection comprises projecting each of the one or more sounding reference signals from a frequency-antenna domain representation onto a delay-beam domain representation.

23. The method of claim 21, further comprising:
outputting a capability message indicating one or more signal processing capabilities of the RU, wherein the one or more signal processing capabilities comprise a capability of the RU to perform a demapping procedure, a descrambling procedure, and an inverse fast Fourier transform procedure on the one or more sounding reference signals, wherein generating the compressed sounding reference signal is based at least in part on the one or more signal processing capabilities.

24. The method of claim 21, further comprising:
obtaining a control message configuring the RU to generate the compressed sounding reference signal, wherein generating the compressed sounding reference signal is based at least in part on the control message.

25. The method of claim 24, wherein generating the compressed sounding reference signal is based at least in part on one or more signal processing capabilities of the RU.

26. The method of claim 24, wherein:
the control message indicates that the RU use a sparse sounding reference signal compression mode for outputting the sounding reference signal report, and
the sparse sounding reference signal compression mode is associated with an inverse fast Fourier transform size for projecting the one or more sounding reference signals from a frequency-antenna domain representation onto a delay-beam domain representation, a threshold associated with one or more near-zero elements of the delay-beam domain representation, or both.

27. The method of claim 21, further comprising:
obtaining a control message indicating a sounding reference signal resource configuration, wherein obtaining the plurality of sounding reference signals is based at least in part on the sounding reference signal resource configuration.

28. The method of claim 27, wherein the sounding reference signal resource configuration comprises an indication of a sounding reference signal resource identifier, a time domain resource position, a frequency domain resource position, a resource type, a base sequence, or any combination thereof.

29. The method of claim 21, further comprising:
outputting, via the sounding reference signal report, an indication of one or more nonzero elements associated with the compressed sounding reference signal and an indication of a respective delay-beam index associated with each of the one or more nonzero elements.

30. A method for wireless communications by a distributed unit (DU), comprising:
obtaining, from a radio unit (RU), a sounding reference signal report indicating a compressed sounding reference signal, the compressed sounding reference signal corresponding to a sparse representation that is indicative of one or more sounding reference signals; and
recovering the one or more sounding reference signals based at least in part on obtaining the compressed sounding reference signal.
